(19) United States
(12) Patent Application Publication
(10) Pub. No.: US 2016/0026983 A1
(43) Pub. Date: Jan. 28, 2016

(54) SYSTEM AND METHOD FOR BROKERING ELECTRONIC DATA IN A NETWORK ENVIRONMENT

(71) Applicant: CISCO TECHNOLOGY, INC., San Jose, CA (US)

(72) Inventors: Dart Lindsley, Santa Cruz, CA (US); Keith Griffin, Galway (IE); Dawn Charlene Chuprevich, Davidson, NC (US)

(73) Assignee: CISCO TECHNOLOGY, INC., San Jose, CA (US)

(21) Appl. No.: 14/340,770

(22) Filed: Jul. 25, 2014

(51) Int. Cl. G06Q 20/12; G06Q 30/06

(52) U.S. Cl. CPC G06Q 20/123; G06Q 30/0635

(57) ABSTRACT

Technologies are disclosed herein that include an embodiment for determining attributes associated with an instrumented entity, determining contract terms for access rights to instrument data associated with the instrumented entity, and creating a data offering for the access rights, where the access rights are based, at least in part, on the attributes and the contract terms. The embodiment further includes publishing the data offering, and providing evidence of rights to a primary data consumer system if a purchased request for the access rights is accepted, where the evidence of rights indicates the access rights are purchased. In more specific embodiments, the access rights include allowing an endpoint to receive the instrument data in real-time when the endpoint presents the evidence of rights.

### TECHNICAL FIELD

This disclosure relates in general to the field of electronic data and, more particularly, to brokering electronic data in a network environment.

### BACKGROUND

The Internet has enabled interconnection of people, processes, data, and things by combining machine-to-machine (M2M), person-to-machine (P2M), and person-to-person (P2P) connections. These networked connections have been referred to as the Internet of Things (IoT) and/or the Internet of Everything (IoE). Information can be extracted from these networked connections to create new capabilities and richer experiences. For example, entities including humans, animals, plants, and things, can be instrumented with one or more sensors to generate data associated with the entities. The applied sensors allow the instrumented entities to be monitored based on the generated data. For example, various types of sensors can be applied to various types of entities to enable traffic monitoring, parking monitoring, road condition monitoring, healthcare monitoring, manufacturing monitoring, military monitoring, environmental monitoring, etc. As sensors become more readily available and affordable, they can be more commonly applied to a broad range of uninstrumented entities. The proliferation of sensors could result in enormous amounts of instrument data being generated. The ability to distribute and access this instrument data presents a significant challenge to data producers and data consumers alike.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a simplified block diagram of a communication system for brokering instrument data in a network environment in accordance with present disclosure;

FIG. 2 is a simplified block diagram illustrating additional details that may be associated with the communication system according to the present disclosure;

FIGS. 3A-3D show an interaction diagram illustrating potential network communications of the communication system according to the present disclosure;

FIG. 4 shows an interaction diagram illustrating other potential network communications of the communication system according to the present disclosure;

FIG. 5 is a simplified flowchart illustrating potential operations of the communication system according to the present disclosure;

FIG. 6 is a simplified flowchart illustrating further potential operations of the communication system according to the present disclosure; and

FIG. 7 is a simplified flowchart illustrating yet further potential operations of the communication system according to the present disclosure.

### DETAILED DESCRIPTION

### Overview

A method is provided in one example of the present disclosure and includes determining attributes associated with an instrumented entity, determining contract terms for access rights to instrument data associated with the instrumented entity, and creating a data offering for the access rights based, at least in part, on the attributes and the contract terms. The method also includes publishing the data offering, and providing evidence of rights to a primary data consumer system if a purchase request for the access rights is accepted, wherein the evidence of rights indicates the access rights are purchased.

This and other embodiments can each optionally include one or more of the following features. The instrument data can be provided to an endpoint in real-time according to access rights information when the endpoint presents the evidence of rights to one of a data provisioning system and an instrument that generates the instrument data. The primary data consumer system can be the endpoint. The method can also include determining one or more subscription parameters configured by a user after the access rights are purchased. A data provisioning system can be configured to provide the instrument data to an endpoint based, at least in part, on the one or more subscription parameters. The data provisioning system can also be configured to provide the instrument data to the endpoint based, at least in part, on access rights information. In addition, at least one of the subscription parameters can supersede at least one contract term specified in the access rights information. Other features can include the contract terms specifying a costing basis for accessing the instrument data or specifying a cost based on at least one of a data access time and a data speed. The method can also include determining a unique identifier associated with the data offering, and mapping the unique identifier to the attributes and the contract terms.

In some embodiments, one or more subscription parameters include at least one of a frequency to send the instrument data, one or more specified data elements of the instrument data to send, an amount of the instrument data to send, and a subscription period during which the one or more subscription parameters remain valid. The contract terms may include a right to distribute the access rights to a secondary data consumer by passing the evidence of rights to a secondary data consumer system.

Other features may include different attributes associated with the instrumented entity. One or more other attributes that include dynamic data associated with the instrument data may be determined. One or more attributes can include static data associated with the instrumented entity. The static data can include at least one of a type of the instrumented entity, a location of the instrumented entity, and an owner of the instrumented entity.

A method is provided in another example of the present disclosure and includes determining one or more attributes indicating a type of instrumented entity and a type of instrument data, creating a data request for access rights to instrument data associated with the one or more attributes, and publishing the data request. The method further includes creating a data offering, in response to the data request, for access rights to available instrument data. The access rights are based, at least in part, on one or more contract terms. The method also includes providing evidence of rights to a primary data consumer system if a purchase request for the access rights to the available instrument data is accepted, where the evidence of rights indicates the access rights are purchased.

Some or all of the features may be included in respective systems or other apparatuses and devices for performing the described functionality. Furthermore, some or all of the features may be implemented in at least one machine readable storage medium.

### DESCRIPTION OF THE EMBODIMENTS

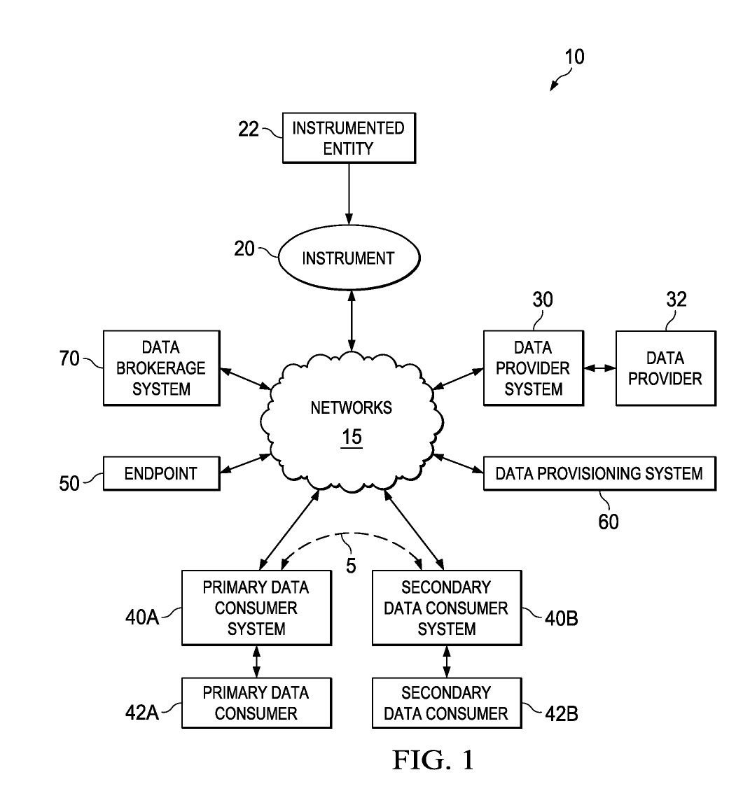

Turning to FIG. 1, FIG. 1 is a simplified block diagram of a communication system 10 for brokering instrument data in a network environment. FIG. 1 includes an instrument 20, a data provider system 30, a data provisioning system 60, a data brokerage system 70, primary and secondary consumer systems 40A and 40B, and an endpoint 50. These components may communicate through one or more networks represented by networks 15. Instrument 20 may be applied to an instrumented entity 22 to sense, extract, measure, or otherwise obtain data associated with the instrumented entity. In one example, an instrumented entity comprises a person, plant, animal, or thing. A data provider 32 can be a person acting on his or her own behalf or as an agent of another person or organization, or a system acting as an agent of a person or organization, distributing rights to access instrument data generated by instrument 20. Data provider 32 may be an actual data producer (e.g., individual or organization) of instrument data or an agent of a data producer. A primary data consumer 42A can be a person acting on his or her own behalf or as an agent of another person or organization, or a system acting as an agent of a person or organization, who enters into a contract to acquire rights to access instrument data from a data provider. A secondary data consumer 42A can be a person acting on his or her own behalf or as an agent of another person or organization, or a system acting as an agent of a person or organization, who receives rights to access instrument data from a primary data consumer system. Purchased access rights may be distributed to a secondary data consumer and evidence of those rights may be passed as indicated at 5, using any suitable network of networks 15 or by using any other suitable data transfer technique.

Data provider 32 may exchange information in communication system 10 by interacting with data provider system 30 (e.g., through a user interface) or with any other computing system capable of exchanging information in a network environment. Primary data consumer 42A may exchange information in communication system 10 by interacting with primary data consumer system 40A (e.g., through a user interface) or with any other computing system capable of exchanging information in a network environment. Secondary data consumer 42B may exchange information in communication system 10 by interacting with secondary data consumer system 40B (e.g., through a user interface) or with any other computing system capable of exchanging information in a network environment. Primary data consumer system 40A can receive evidence of rights to access instrument data when the access rights have been acquired by primary data consumer 42A. In addition, secondary data consumer system 40B can receive, from a primary data consumer system (e.g., primary data consumer system 40A), evidence of rights to access instrument data acquired by the primary data consumer.

Elements of FIG. 1 may be coupled to one another through one or more interfaces employing any suitable connections (wired or wireless), which provide viable pathways for network communications. Additionally, any one or more of these elements of FIG. 1 may be combined or removed from the architecture based on particular configuration needs. Communication system 10 may include a configuration capable of transmission control protocol/internet protocol (TCP/IP) communications for the transmission and/or reception of packets in a network. Communication system 10 may also operate in conjunction with a user datagram protocol/IP (UDP/IP) or any other suitable protocol, where appropriate and based on particular needs.

For purposes of illustrating certain example techniques of communication system 10, it is important to understand the communications that may be traversing communication system 10 shown in FIG. 1. The following foundational information may be viewed as a basis from which the present disclosure may be properly explained. Such information is offered for purposes of explanation only and, accordingly, should not be construed in any way to limit the broad scope of the present disclosure and its potential applications.

As sensor technology has progressed, it has become possible to generate electronic data associated with a wide range of entities. The electronic data can provide many different types of information related to those entities. An ‘instrument’ as used herein, is intended to mean an electronic device or sensor that can be applied to an entity to sense, detect, extract, measure, and/or otherwise obtain some type of input (e.g., a physical quantity or quantities) associated with the entity. A physical quantity can include any property of an entity that can be measured. This input is typically converted to a signal. Examples of possible types of input can include, but are not limited to, temperature, pressure, light, heat, sound, time, electric current, and other types of environmental phenomena. An instrument may include one or more sensors and may also be configured with appropriate hardware, firmware, and/or software to obtain electronic data from the signal or signals (or the input) that can be communicated via an electronic transmission over a network. The electronic data (also referred to herein as “instrument data”) can be a meaningful representation of information associated with the entity and can be processed by a computing system or device. Input (or signals) could also be used in some implementations to derive instrument data that represents other properties of an entity that may not be quantifiable such as quality, change, relation, etc. of the entity.

Generally, an entity to which an instrument is applied or could be applied can be a person, animal, plant, or thing. As used herein, an ‘instrumented entity’ is an entity to which one or more instruments are applied to generate data related to the instrumented entity. Instruments can be applied to persons, animals, plants, or things to enable monitoring conditions related to the particular entity. For example, conditions could be monitored that are related to traffic, parking, roads, healthcare facilities and items, medical patients, manufacturing, military hardware or personnel, the natural environment or nature, chemical substances, biological attributes of living organisms, health of a person, etc. By way of example, and not of limitation, instruments could be applied to: 1) parking spaces in a city parking lot or garage to monitor parking availability and capacity, 2) soil in a field to monitor moisture and soil content, and 3) a person to monitor health conditions (e.g., diabetes, heart conditions, etc.). Consequently, the potential for generating massive amounts of electronic data is significant.

A data producer may want and/or need to advertise, sell, contract, and/or grant rights to their electronic data to one or more data consumers. A data producer may also want to collect fees for the use or consumption of their data from one or more data consumers. On the other hand, a data consumer may want and/or need to advertise needs and/or wants regarding instrument data, search and browse available data offerings (e.g., from data producers), contract and receive rights to access, prove rights to access data, and/or pay for the use or consumption of the data. Additionally, a data consumer may want to act as a reseller and/or may want to enable endpoints to have access to instrument data. Currently there is no vehicle that enables these activities.

Some currently available Internet services provide for the advertisement and sale of certain items. For example, some Internet services allow online classified advertisements and embody methods for direct marketing and sales of goods and services by individuals. Some Internet financial services bundle and re-sell both historical and financial data within the vertical of financial services. These providers often collect financial data from various sources and set up private storefronts to market the collected financial data. In another example, digital rights management (DRM) software enables distribution of computer game software, recorded music, text, and applications involving games, recorded music, and text. Such software can allow game makers to market games via a stream platform, and can allow users to search, browse, and purchase games. Similarly, DRM software can enable similar types of activities related to recorded music and electronic text. None of these services, however, provides a brokerage platform that is available to providers of real-time instrument data to broker and sell access rights to their real-time instrument data, where access rights and subscription parameters can be negotiated and configured for accessing instrument data, where access rights can include the right to distribute purchased access rights to multiple endpoints and/or other data consumers, where data consumers can find and purchase access rights to desired instrument data, and where data consumers can publish advertisements (or data requests) seeking to purchase desired instrument data.

In accordance with one example implementation, communication system 10 can resolve the aforementioned issues associated with brokering and sales of instrument data. More specifically, communication system 10 provides a brokerage service that enables data providers of real-time (and static) instrument data to advertise the instrument data for sale online. Communication system 10 also enables data consumers to search and browse for instrument data, purchase rights, distribute rights to other data consumers, and pass evidence of rights to endpoints and other data consumer systems. In addition, communication system 10 allows data consumers to advertise data requests, and allows data providers to search and browse for a particular data request, and to sell access rights to instrument data that satisfies the particular data request. Communication system 10 enables any number of contractual arrangements to be formed between data providers and data consumers via data brokerage system 70. Evidence of rights can be used in communication system 10 to enable endpoint 50 to access instrument data according to access rights that have been purchased by the primary data consumer via primary consumer system 40A, for example. The purchased access rights can include the right to distribute (e.g., sell, transfer, share, etc.) the purchased access rights to one or more other (secondary) data consumers. Evidence of rights can be passed using any suitable network connection from a primary data consumer system to a secondary data consumer system (which could be an endpoint capable of consuming the instrument data) or by any other data transfer technique (e.g., manual entry, providing access to a data storage device, etc.).

Communication system 10 includes several advantageous features. Communication system 10 provides a service to data providers of any type of instrument data to market their real-time (and static) data. Communication system 10 further provides a service to data consumers of such data to purchase access rights to real-time and/or static instrument data. This service also enables data consumers to publish data requests for any type of instrument data and to receive data offerings or bids to supply the instrument data. Advertising (or publishing) data for sale may occur across all vertical markets, rather than producing and selling instrument data within a single vertical market (i.e., a particular industry, trade, profession, or other group of customers with specialized needs). A metadata framework of attributes enables instrument data to be described for purposes of marketing the data. The attributes can include an indicator that can be provided at the point of purchase to show when real-time instrument data is immediately available. Communication system 10 further enables drafting and managing contract terms unique to instrument data (e.g., frequency, number of endpoints, distribution rights, appropriate use, etc.). Data consumers can configure data subscriptions to maximize utility and minimize data volume. Communication system 10 facilitates the ability to pass ‘evidence of rights’ to endpoints for accessing instrument data. Communication system 10 may also facilitate the ability to distribute access rights to a secondary data consumer and to pass ‘evidence of rights’ to a corresponding secondary data consumer system. Possession of evidence of rights enables endpoints to access instrument data associated with the evidence of rights. Also, communication system 10 allows a costing basis (e.g., per megabyte, per period, per endpoint, etc.) to be specified in contract terms and then can monitor data usage for purposes of billing the data consumer.

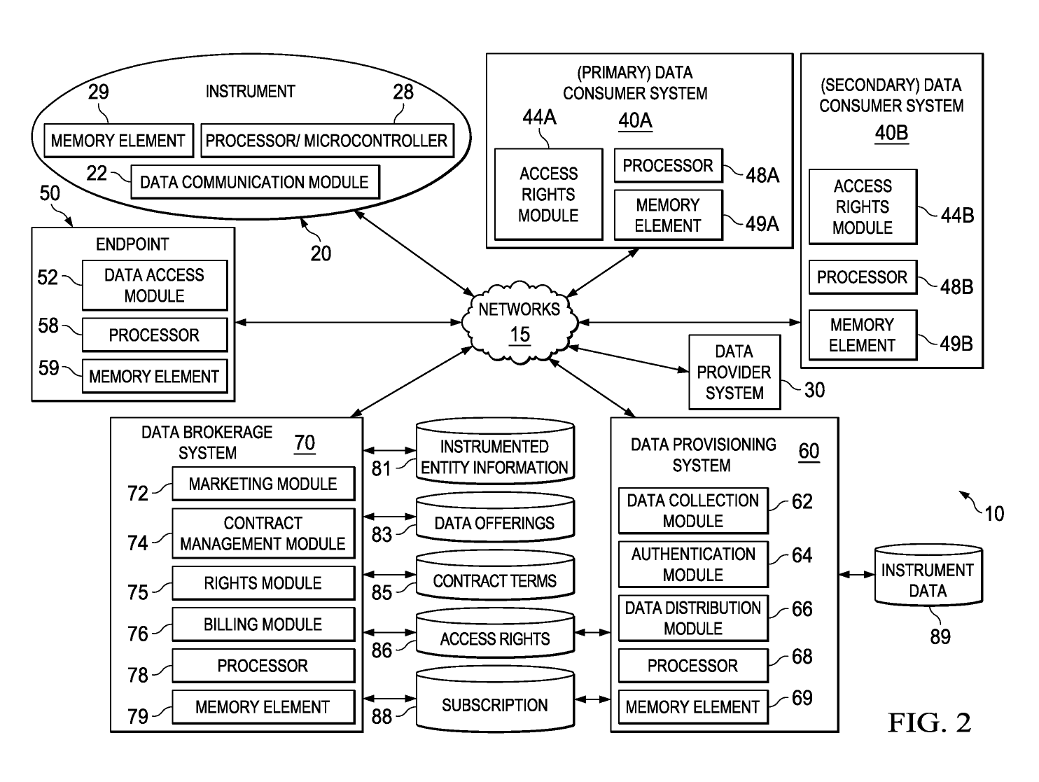

Turning to FIG. 2, FIG. 2 is a simplified block diagram illustrating one possible set of details associated with communication system 10. Before discussing potential flows associated with the architecture of FIG. 2, a brief discussion is provided about some of the possible components and infrastructure that may be associated with communication system 10.

Generally, communication system 10 can include any type or topology of one or more networks, indicated by networks 15. Networks 15 represent a series of points or nodes of interconnected communication paths for receiving and sending network communications (e.g., packets of data) that propagate through communication system 10. Networks 15 offer a communicative interface between nodes, and may include any local area network (LAN), virtual local area network (VLAN), wireless local area network (WLAN), metropolitan area network (MAN), wide area network (WAN) such as the Internet, Intranet, Extranet, virtual private network (VPN), and any other appropriate architecture or system that facilitates communications in a network environment, or any suitable combination thereof. More specifically, networks 15 may include any wireless (e.g., 3G/4G/5G/nG network, WiFi, Institute of Electrical and Electronics Engineers (IEEE) Std 802.11™-2012, published Mar. 29, 2012, WiMax, IEEE Std 802.16™-2012, published Aug. 17, 2012, Radio-frequency Identification (RFID), Near Field Communication (NFC), Bluetooth′, etc.) and/or wire line (e.g., Ethernet, etc.) communication capabilities. Generally, any suitable means of communication may be used: electric, sound, light, infrared, radio (e.g., Wifi, Bluetooth, NFC, etc.).

Network flows (also referred to as ‘network communications’ and ‘network transmissions’), which can be inclusive of packets, frames, signals, data, objects, etc., can be sent and received according to any suitable communication messaging protocols. Suitable communication messaging protocols can include a multi-layered scheme such as Open Systems Interconnection (OSI) model, or any derivations or variants thereof (e.g., Transmission Control Protocol/Internet Protocol (TCP/IP), user datagram protocol/IP (UDP/IP), etc.). The term ‘data’ as used herein, refers to any type of binary, numeric, voice, video, textual, photographic, or script data, or any type of source or object code, or any other suitable information in any appropriate format that may be communicated from one point to another in computing devices (e.g., systems, endpoints, servers, instruments) and/or networks. Additionally, messages, requests, responses, replies, queries, etc. are forms of network flows.

In at least one embodiment of communication system 10, components are provisioned with various hardware and software to facilitate the brokerage activities of communication system 10. For example, instrument 20 can include a data communication module 22, a processor/microcontroller 28, and a memory element 29; data consumer systems 40A and 40B can include respective access rights modules 44A and 44B, respective processors 48A and 48B, and respective memory elements 49A and 49B; endpoint 50 can include a data access module 52, a processor 58, and a memory element 59; data provisioning system 60 can include a data collection module 62, an authentication module 64, a data distribution module 66, a processor 68, and a memory element 69; and data brokerage system 70 can include a marketing module 72, a contract management module 74, a rights module 75, a billing module 76, a processor 78, and a memory element 79. Data provider system 30 can also include appropriate software and hardware (e.g., browsers, processors, memory elements) for interacting with other components in communication system 10. Additionally, at least some components of FIG. 2 (e.g., data provider system 30, primary data consumer system 40A, endpoint 50) may also include at least one web browser for retrieving and presenting resources from the data brokerage web service of communication system 10.

Instrument 20 represents a component of communication system 10 that provides instrument data, for which access rights can be purchased via a data brokerage service of communication system 10. Instrument 20 can be a sensor that is applied to a particular person, animal, plant, or thing and that generates instrument data related to the instrumented entity. Alternatively, instrument 20 could be a system that collects instrument data from multiple sensors applied to a single entity or to multiple entities of a group of entities, and that generates instrument data for the single instrumented entity or for the instrumented entities of the group. Although a single instrument is provided in FIGS. 1-2, this is for ease of illustration and description only. It will be apparent that any number of instruments may be provided in communication system 10 and may generate many different types of instrument data for which access rights can be bought and sold.

In one example, instrument 20 may include data communication module 22, which is configured to enable instrument 20 to communicate instrument data to appropriate systems. For example, data communication module 22 may be configured to provide a continuous, real-time stream of instrument data to data provisioning system 60, or real-time instrument data on demand, thus allowing endpoints to access the real-time instrument data from data provisioning system 60. Data communication module 22 may also be configured to provide batch updates of instrument data to data provisioning system 60.

In some embodiments, access rights purchased for instrument data of instrument 20 may allow an endpoint to bypass data provisioning system 60 and to communicate with instrument 20 directly to access the desired instrument data. In these embodiments, the instrument may be configured to perform at least some of the same or similar functions as described herein with reference to data provisioning system 60 and/or data brokerage system 70. For example, instrument 20 may be configured with an authentication module (e.g., similar to authentication module 64 of data provisioning system 60) to ensure that the endpoint requesting access to instrument data provides valid evidence of rights to access the instrument data. In some embodiments, instrument 20 may also be configured with a rights module (e.g., similar to rights module 75 of data brokerage system 75) to allow a data consumer to configure a subscription for receiving instrument data. Data communication module 22 may ensure compliance with any subscription parameters associated with the evidence of rights (e.g., selected data elements, frequency such as instrument data sent every day, week, month, year, etc., amount of instrument data, subscription period, etc.).

Primary and secondary data consumer systems 40A and 40B can be associated with human end users, such as respective primary and secondary data consumers 42A and 42B (shown in FIG. 1), who can interact with systems 40A and 40B to initiate information exchanges in communication system 10 over networks 15. Primary data consumer 42A may be associated with activities that include one or more of browsing and/or searching data offerings, purchasing access rights for selected data offerings, publishing data requests, configuring a subscription for accessing instrument data, distributing purchased access rights to secondary data consumers, and/or other activities related to participating in a brokerage service for instrument data. These activities may be performed using any computing systems capable of exchanging information in communication system 10, including primary data consumer system 40A. Primary data consumer system 40A represents a computing system that can be used to receive evidence of purchased access rights for instrument data, pass the evidence of rights to one or more endpoints for consuming data, and pass the evidence of rights to another data consumer system (or endpoint) associated with a secondary data consumer in order to sell, transfer, or otherwise distribute the purchased access rights to the secondary data consumer.

Secondary data consumer 42B may be associated with activities that include one or more of purchasing or otherwise obtaining access rights from a primary data consumer and configuring a subscription for accessing instrument data. In at least one embodiment, these activities may be performed using secondary data consumer system 40B. Secondary data consumer system 40B represents a computing system that can also be used to receive evidence of purchased access rights for instrument data, pass the evidence of rights to one or more endpoints for consuming data, and possibly pass the evidence of rights to another data consumer system (or endpoint) associated with another data consumer in order to sell, transfer, or otherwise distribute the purchased access rights to the other data consumer. Depending on the original contract terms defining the purchased access rights, the right to distribute purchased access rights to other data consumers could remain part of the access rights each time the access rights are sold, transferred, or otherwise distributed to a secondary data consumer or to any other data consumers.

Data provider system 30 can also be associated with a human end user such as data provider 32 (shown in FIG. 1), who can initiate information exchanges in communication system 10 via networks 15. Data provider 32 can be associated with activities to create data offerings, configure contract terms for the data offerings, publish data offerings, browse data requests, create data offerings for and/or bid on a selected data request, and/or any other activities related to participating in a brokerage service for instrument data. Any number of individuals, groups of individuals, and/or organizations (e.g., businesses, governments, schools, churches, non-profit agencies, military organizations, etc.) could participate in the brokerage service to broker and sell instrument data.

The terms data consumer system′ and data provider system′ are intended to mean computing systems and are inclusive of devices used to initiate a communication in a network environment, including for example, computing devices, mobile devices (e.g., smartphone, tablet, infotainment systems, etc.), laptops, desktops, servers, or any other device, component, element, or object capable of initiating voice, audio, video, media, or other data exchanges within communication system 10. Data consumer systems 40A and 40B and data provider system 30 may also be inclusive of a suitable interface to the human user, such as a display, a mouse, a keyboard, a touchpad, a touchscreen, a trackball, a remote control, any other terminal equipment and/or input devices or any suitable combination thereof. Data consumer systems 40A and 40B and data provider system 30 may also be any element that seeks to initiate a communication on behalf of another entity, element, or human, such as a program, a database, or any other component, device, or object capable of initiating an exchange within communication system 10.

In at least some embodiments, data consumer systems 40A and 40B may include respective access rights module 44A and 44B, to enable data consumer systems 40A and 40B to pass evidence of rights to their respective endpoints to enable the endpoints to access instrument data for which access rights have been purchased. In some instances, a data consumer system may also act as an endpoint and may access instrument data once access rights have been purchased and evidence of rights has been received by the data consumer system. Access rights module 44A of primary data consumer system 40A may also be configured to enable the transfer, sale, or other distribution of access rights to a secondary data consumer (e.g., via secondary data consumer system 40B) by at least passing the evidence of rights to secondary data consumer system 40B. In some embodiments, access rights module 44B of secondary data consumer system 40B may be similarly configured to enable the further transfer, sale or other distribution of the access rights to other data consumer systems, if allowed by the original contract terms.

Endpoint 50 represents a system that consumes instrument data. Although a single endpoint 50 is illustrated in FIGS. 1-2, this is done for ease of illustration and explanation. Each data consumer system (e.g., 40A, 40B) in communication system 10, and its associated data consumer (e.g., 42A, 42B), may be associated with one or more endpoints. If purchased access rights allow it, multiple endpoints may be used to consume instrument data for which access rights are purchased via a particular data consumer system. For example, endpoint 50 and possibly other endpoints may consume instrument data for which access rights were purchased, and for which evidence of rights were received on primary data consumer system 40A. Another endpoint may be used to consume instrument data for which access rights were purchased from primary data consumer 42A, and for which evidence of rights were received on secondary consumer system 40B. Endpoints may be possessed by primary or secondary data consumers, and can provide access to instrument data for their respective primary or secondary data consumers. The instrument data consumed by the endpoints could be raw data or analyzed data, or could be integrated with a service.

Like data consumer systems and data provider system, endpoint 50 can be a computing system capable of initiating communications in a network environment including for example, computing devices, mobile devices (e.g., smartphone, tablet, infotainment systems, etc.), laptops, desktops, servers, or any other device, component, element, or object capable of initiating voice, audio, video, media, or other data exchanges within communication system 10. Endpoint 50 may also be inclusive of a suitable interface to the human user, such as a display, a mouse, a keyboard, a touchpad, a touchscreen, a trackball, a remote control, any other terminal equipment and/or input devices or any suitable combination thereof. In some example scenarios, if endpoint 50 is associated with primary data consumer system 40A, then primary data consumer 42A may possess and interact with endpoint 50 to access instrument data once the evidence of rights for the instrument data has been passed to endpoint 50 (e.g., from primary data consumer system 40A or directly from data brokerage system 70). This may be particularly common when individuals purchase access rights to instrument data via a data consumer system. This common scenario, however, is provided for illustrative purposes only, and it should be apparent that any number of individuals and/or organizations (e.g., businesses, governments, schools, churches, non-profit agencies, military organizations, etc.) could participate in purchasing and consuming instrument data as primary and/or secondary data consumers, each having their own consumer systems and endpoints to enable accessing the instrument data.

Some endpoints of communication system 10 can be software that consumes instrument data, such as for data analysis. For example, an endpoint could be software residing on a server or other computing system and configured to access instrument data automatically, without necessarily involving a human end user such as data consumers 42A and 42B. Also, as previously noted, a data consumer system (e.g., 40A, 40B) could serve as an endpoint such that access rights are purchased and instrument data is consumed via the data consumer system.

Data provisioning system 60 and data brokerage system 70 are systems of one or more network elements that form a brokerage platform that provides a brokerage service to enable advertising data offerings and data requests, and buying and selling rights to instrument data. In at least one embodiment, this brokerage service could be accessed via the Internet and could be configured as a web service. As used herein, the term ‘network element’ is meant to encompass servers, server clusters, routers, switches, gateways, bridges, loadbalancers, firewalls, inline service nodes, proxies, processors, modules, or any other suitable device, component, element, proprietary appliance, or object operable to exchange information in a network environment. A network element may include any suitable hardware, software, components, modules, interfaces, or objects that facilitate the operations thereof. This may be inclusive of appropriate algorithms and communication protocols that allow for the effective exchange of data or information.

In at least one embodiment, repositories associated with data provisioning system 60 can include an instrument data repository 89, and repositories associated with data brokerage system 70 can include an instrumented entity information repository 81, a data offerings repository 83, and a contract terms repository 85. In at least one embodiment, an access rights repository 86 and a subscription repository 88 may be associated with both data provisioning system 60 and data brokerage system 70. One or more of these repositories can be internal to data provisioning system 60, internal to data brokerage system 70, external (entirely or in part), or any suitable combination thereof. Internal storage could include any internal memory of data provisioning system 60 or data brokerage system 70, such as static storage, random access memory (RAM), or cache, for example. External storage could include a network storage technique such as network attached storage (NAS) or storage area network (SAN), or the internal memory of another network element.

As indicated by FIG. 2, information contained in access rights repository 86 and subscription repository 88 is associated with both data provisioning system 60 and data brokerage system 70. These repositories may be configured in any number of different ways. For example, they could be shared or duplicated in whole or in part to enable access by data provisioning system 60 and data brokerage system 70. In one example, these repositories could be configured to enable access by both data provisioning system 60 and data brokerage system 70. In another example, the information in repositories 86 and 88 could be provided to data provisioning system 60 from data brokerage system 70, in whole or in part, and data provisioning system 60 could store the information in suitable storage elements.

Data provisioning system 60 may include a data collection module 62 for receiving instrument data from instruments (e.g., instrument 20). The data could be received using any desired method, for example, real-time updates, batch updates, on-demand, etc., or any suitable combination thereof. The data collection could employ a pull technique, a push technique, or a suitable combination thereof. Data provisioning system 60 may store instrument data in instrument data repository 82, which can be accessed by endpoints having a valid evidence of rights for the instrument data. Data provisioning system 60 may not always store the instrument data in a repository, but may simply receive it from the instrument and forward it to an authenticated endpoint that requests the data. In at least one embodiment, a data provider may interact with appropriate user interfaces associated with the brokerage service in order to configure data provisioning system 60 to perform data collection for a particular instrument.

Data provisioning system 60 may also include authentication module 64 and data distribution module 66 for managing authorized distribution of instrument data. In at least one embodiment, the management of authorized distribution of instrument data can be implemented with appropriate user interfaces to enable interaction between a user of endpoint 50 (e.g., primary data consumer 42A) and data provisioning system 60. In some scenarios, authorized distribution of instrument data may occur without user involvement (e.g., when distribution is set up to occur automatically at periodic intervals, when endpoint 50 is software that consumes the data, etc.).

Authentication module 64 of data provisioning system 60 can be configured to determine whether an endpoint that requests access to instrument data provides valid evidence of rights for the requested instrument data. A valid evidence of rights indicates that access rights have been purchased for particular instrument data. Evidence of rights can include any information in any appropriate format that indicates that access rights have been purchased for particular instrument data. In at least one example, evidence of rights may be an object such as a coded token or a file. A coded token could include, for example, any suitable form of data such as, but not limited to, numeric, alphabetic, alphanumeric, symbolic, etc., or any suitable combination thereof. Access rights repository 86 may store the evidence of rights and access rights information associated with the evidence of rights.

Access rights to instrument data, as described herein, can include one or more permissions granted to access (e.g., receive, retrieve, read, copy, etc.) the particular instrument data by at least one endpoint, according to one or more contract terms. Access rights can be purchased on either on an on-going basis or as a snapshot. On-going access rights can remain valid during a defined period of time (i.e., a contract period) or can remain valid indefinitely (i.e., unlimited period of time). A snapshot includes access rights to instrument data at a particular point in time. For example, a data consumer may purchase parking lot instrument data on a one-time, immediate basis when visiting a city and searching for a place to park. Access rights information can define purchased access rights and can include, but is not limited to, an identification of which instrument data can be accessed (e.g., from instrument 20), how much instrument data can be accessed (e.g., if contract terms limit the amount of instrument data that can be accessed, the number of times instrument data can be accessed, etc.), and any other contract terms accepted in the purchase that are needed to properly manage access requests for the instrument data (e.g., distribution rights, number of endpoints, contract period, specific data elements, etc.).

When presented by an endpoint, an evidence of rights (e.g., coded token) may be evaluated by authentication module 64 to determine whether it is valid. Any suitable validation techniques could be used including, but not limited to, asymmetric key cryptography or symmetric key cryptography. A validated evidence of rights can indicate that a possessor of the evidence of rights (e.g., an endpoint that presented the evidence of rights) is entitled to access particular instrument data based on access rights information (and subscription parameters, if any) for the particular instrument data. If the evidence of rights is determined to be valid, then the endpoint is authenticated, and data distribution module 66 can distribute the requested instrument data to the endpoint, according to the access rights information (and subscription parameters, if any) associated with the evidence of rights.

In some scenarios, access rights that have been purchased may be associated with a subscription for receiving the instrument data. Generally, subscriptions are associated with on-going access rights and comprise parameters defining how, what and/or when instrument data is to be received. Some parameters may be configurable by a user (e.g., data consumer) including, but not limited to, frequency of receiving instrument data, specific data elements to be received, amount of instrument data to receive, subscription period for receiving instrument data, etc. Accordingly, data distribution module 66 may access subscription repository 88 to determine what subscription, if any, applies to the instrument data for the particular access rights of the endpoint making the request, and then comply with the parameters of the identified subscription.

In some examples, the subscription may be evaluated each time an endpoint requests access to instrument data. In other examples, the subscription may include a frequency parameter that requires data provisioning system 60 to provide real-time or static data updates to the endpoint based on a particular frequency (e.g., hourly, daily, weekly, etc.). In these instances, once the endpoint has been authenticated, data provisioning system 60 may automatically provide the instrument data to the endpoint according to the particular parameters of the subscription. In at least one embodiment, the endpoint could be configured with a module to ping data provisioning system 60, in order to establish a network session, whenever instrument data should be downloaded according to the subscription.

In at least one embodiment, data brokerage system 70 can be implemented, at least partially, as a data brokerage web service with appropriate user interfaces to enable interaction between data consumers 42A, 42B and data brokerage system 70, and between data provider 30 and data brokerage system 70. Data brokerage system 70 can include marketing module 72 to allow data providers (e.g., data provider 32) to create data offerings with selected contract terms and to publish the data offerings. For example, to create a data offering for access rights to instrument data of instrumented entity 22, data provider 32 can begin by accessing data brokerage system 70 via data provider system 30 (or any other suitable computing system), to create a record for instrumented entity 22. As used herein, a ‘record’ is intended to include any data structure in which electronic data can be stored including, but not limited to, files, structs, objects, lists, tables, linked lists, stacks, queues, arrays, S-expressions, etc.

A catalog of one or more attributes related to instrumented entity 22, instrument 20, and the instrument data being generated, may also be included in the record (or stored in another data structure associated with the record). The attributes can include details of both static data and dynamic data. Dynamic data is generally descriptive of, or otherwise associated with, instrument data generated by instrument 20. Details of dynamic data could include, but are not limited to, one or more of size (e.g., bytes per time period), frequency (e.g., how often the instrument data can be produced and/or sent), data elements, data format, indicator of whether the feed is currently active (e.g., bit set for yes/active or no/inactive), delay, accuracy, precision, any other attributes of the instrument data including data samples, etc. Static data is generally descriptive of, or otherwise associated with, instrumented entity 22 and/or instrument 20. Details of static data could include, but are not limited to, one or more of entity type(s), entity location(s), entity owner(s), instrument type(s), instrument location(s), instrument maker, number of sensors, network address of instrument (e.g., IP address, media access control (MAC) address, uniform resource locator (URL), etc.). In at least one embodiment, one or more of the attributes can be entered through a user interface of the data brokerage web service by data provider 32 using any suitable computing system to access the web service. In some embodiments, one or more of the attributes may be uploaded from the instrument itself.

In at least one embodiment, marketing module 72 enables creation of a data offering. A ‘data offering’ as used herein, is intended to mean an offer to sell, via any suitable method (e.g., non-negotiable purchase, negotiable purchase, auction, etc.), access rights to instrument data generated by one or more instruments applied to one or more instrumented entities. A data offering may be created based on (and may include information from) a record created for an instrumented entity and contract terms or sets of contract terms configured for access rights to the instrument data. If instrument data from multiple instruments are packaged into one data offering, the data offering may be created based on (and may include information from) multiple records and contract terms or sets of contract terms configured for access rights to the instrument data. The particular method of sale (e.g., non-negotiable purchase, negotiable purchase, auction, etc.) allowed by the data offering may be configurable by the data provider bringing the instrument data to market.

A unique identifier may be associated with a data offering. A unique identifier could be any identifier that is numeric, alphabetic, alphanumeric, symbolic, etc., or any suitable combination thereof, and that uniquely identifies the data offering. According to at least one embodiment of the present disclosure, a data offering for access rights to particular instrument data can be created by retrieving and storing (e.g., in data offerings repository 83): 1) a unique identifier, 2) the desired attributes from a record or records associated with the particular instrument data that can be accessible to data consumers when searching, and 3) contract terms or sets of contract terms configured for access rights to the particular instrument data. In at least one other embodiment, a data offering can be created by mapping one or all of these to each other. As used herein, ‘mapping’ is intended to include any suitable mapping, marking, or linking technique (e.g., pointers, indexes, file names, relational databases, hash table, etc.), or any other technique that represents a relation, connection, association, or link between the ‘mapped’ items.

In some scenarios, a data offering may be associated with a single instrumented entity having a single instrument (e.g., instrument 20 and instrumented entity 22). In such cases, the unique identifier can also uniquely identify the instrument. In some other scenarios, a data provider could package (or combine) two or more instruments (and possibly two or more instrumented entities) into a single data offering. When instruments are packaged in a data offering, a unique identifier identifies the data offering and the collective instruments packaged for the data offering. In one example, a single instrumented entity could be a human with multiple sensors applied (e.g., blood sugar, heart rate, etc.). All of the instruments (i.e., the sensors applied to the human being) could be packaged as a single data offering with one instrumented entity, the human. In another example, for a parking garage with a different sensor applied to each one of many different parking spaces, it may be desirable to package all of the sensors in the parking garage in order to sell access rights to instrument data for the garage as a whole rather than instrument data for each individual parking space in the garage.

Marketing module 72 can publish the data offering on the data brokerage web service. As used herein, ‘publishing’ is intended to mean to advertise, disclose, or otherwise make available to the public or selected segments of the public, a data offering (or data request). The data offering (or data request) can include one or more attributes of the instrumented entity, the instrument, and/or the instrument data, in addition to one or more contract terms or sets of contract terms. Publishing a data offering enables the instrument data to be discovered by a potential buyer as a result of searching and/or browsing activities on data brokerage system 70. Thus, in one example, a data consumer may be able to discover the data offering by accessing appropriate user interfaces of data brokerage system 70 using a suitable computing system, and searching on key terms related to the attributes of the instrument data, the instrumented entity, or the instrument described in the data offering or using any other appropriate search criteria.

A data provider, such as data provider 32, may also access data brokerage system 70 in order to search and/or browse data requests that are published by data consumers. As used herein, a data request′ is intended to mean a request to buy (or an offer to buy), via any suitable method (e.g., non-negotiable purchase, negotiable purchase, auction, etc.), access rights to instrument data described in the data request. A data request may be created by a data consumer and may specify any desired attributes and/or contract terms, which may be indicated as negotiable or non-negotiable. The particular method of sale (e.g., non-negotiable purchase, negotiable purchase, auction, etc.) allowed by the data request may be configurable by the data consumer bringing the offer to buy instrument data to market.

Contract management module 74 may also be provisioned in data brokerage system 70 to enable a data provider to publish contract terms under which access rights to instrument data may be purchased. In at least one embodiment, one or more contract terms or sets of contract terms may configured for a data offering. As used herein, the phrase ‘contract terms’ is intended to mean conditions and/or warranties that form the basis of a contract (or agreement) between a data provider and a data consumer related to the purchase of access rights to instrument data. For a particular data offering, the associated data provider can configure and publish selectable or fixed contract terms or sets of contract terms. In some cases, a data offering may be configured to allow negotiation of the contract terms with the primary data consumer.

Data consumers can submit a purchase request for access rights to instrument data associated with the data offering. The purchase request can represent either 1) an agreement or offer to purchase access rights according to contract terms of the data offering, or 2) a bid to purchase access rights according to contract terms of the data offering (e.g., in an auction scenario). The contract terms of the data offering may be selected by the data consumer or fixed, depending on how the data offering was configured by the data provider.

Examples of contract terms that can be configured and published by a data provider include, but are not limited to price (e.g., based on data access time, based on data speed, etc.), costing basis (e.g., per period, per megabyte, per endpoint, etc.), acceptable use (e.g., reproduce, destroy, modify, share, etc.), options for rights to distribute purchased access rights to other data consumer systems (e.g., transfer, sell, share, etc.), limits to the number of end users or endpoints, exclusivity options (e.g., yes/no), acceptable delay, frequency, contract period (i.e., defined period of time during which access rights remain valid), number of times instrument data can be accessed (e.g., once for snapshot access), amount of instrument data that can be accessed, available data elements, and any other desired limitation. In at least one embodiment, some of the aforementioned possible contract terms may also, or alternatively, be configured as subscription parameters by a user, such as primary data consumer 42A, after purchasing access rights to instrument data. Configured contract terms may be stored in contract terms repository 85. Additionally, standard contract terms that are available for selection when a data provider is configuring contract terms for a data offering may also be stored in contract terms repository 85 and may be displayed by a user interface via, for example, data provider system 30.

Data brokerage system 70 may allow data provider to set a cost for instrument data based on time. For example, access rights that permit per millisecond access to the instrument data may be set to a higher cost than access rights that permit per second access, access rights that permit per second access to the instrument data may be set to a higher cost than per minute access, and so forth. Similarly, a data provider may set a cost according to the speed of accessing instrument data. For example, a cost of accessing real-time instrument data may be set higher than a cost for accessing non-real-time instrument data. In at least some scenarios, these costs may be specified in contract terms offered by the data provider. In other scenarios, these costs may be negotiated by a data provider and a data consumer via data brokerage system 70.

Rights module 75 can be provisioned in data brokerage system 70 to enable a data consumer to configure a subscription for receiving instrument data associated with purchased on-going access rights. Rights module 75 could also, or alternatively, be provisioned in data provisioning system 60 and subscriptions could be configured through data provisioning system 60. In some embodiments, one or more instruments could allow data consumers to configure subscriptions through the instrument itself. For example, when access rights enable direct access to an instrument, a data consumer could configure a subscription directly with the instrument rather than via data brokerage system 70 or data provisioning system 60.

Generally, user-configurable subscription parameters may be used to maximize utility and minimize data volume. This may be especially desirable, for example, when an instrument produces enormous volumes of instrument data. Subscriptions can include parameters related to amounts of data received (e.g., total megabytes, etc.), types of data received (e.g., specific data elements), timing of data received (e.g., frequency), duration or amount of time the user-configured subscription parameters remain valid (i.e., subscription period), etc. In at least one embodiment, user-configured subscription parameters may be stored in subscription repository 88 and may be associated with the purchased access rights (e.g., by mapping to evidence of rights).

In at least one embodiment, subscription parameters may be configured by a primary data consumer after access rights have been purchased. The user-configured subscription parameters may be narrower than (or a subset of) the purchased access rights and may supersede one or more of the access rights while the subscription is valid. For example, purchased access rights might include all data elements generated by the instrument. The data consumer may configure subscription parameters that permit only selected data elements to be received by an endpoint. In another example, the purchased access rights might include a certain contract period, while the data consumer may configure a subscription period less than the actual contract period. To illustrate an example scenario, a commodities trader may purchase access rights to instrument data related to field and weather conditions for several crops of interest for a contract period of 5 years. The commodities trader may configure subscription parameters in order to automatically receive instrument data related to a particular crop during a subscription period corresponding to the growing season for the particular crop.

Another user-configurable subscription parameter may specify an amount of instrument data to be provided to an endpoint. For example, a subscription parameter could be configured to limit the amount of data (e.g., by megabyte, etc.) received during a particular frequency interval. This may be particularly useful for instrument data that includes many data elements that are frequently updated.

In at least one embodiment, one or more user-configurable subscription parameters may be configured as part of purchasing access rights (e.g., by selecting and/or negotiating contract terms). Accordingly, the access rights may be defined, at least in part, by these subscription parameters. For example, the primary data consumer may be able to select (or negotiate) particular data elements and a subscription period for the purchase. Thus, the user-selected data elements and/or the user-selected subscription period can be part of the original contract terms and, therefore, included in the purchased access rights. These specific subscription parameters are described for illustration purposes only, and it will be apparent any other subscription parameters could also or alternatively be configured as part of the original contract terms.

In at least one embodiment, billing module 76 can be provisioned in data brokerage system 70 to enable data brokerage system to bill a data consumer for data usage. The contract price of access rights can be configured in the contract terms. In some instances, a contract term can include billing based on data usage (or access to data). Data usage information can be obtained from data provisioning system 60 and/or instrument 20, depending on whether an endpoint accesses instrument data from data provisioning system 60 or directly from instrument 20. Billing module 76 can bill the data consumer associated with the endpoint based on actual data accessed by the endpoint.

In at least one embodiment, each of the components of communication system 10 (i.e., computing systems, network elements, and instruments), including instrument 20, data provider system 30, data consumer systems 40A and 40B, endpoint 50, data provisioning system 60, and data brokerage system 70, include software to achieve (or to foster) the brokerage activities for instrument data, as outlined herein. Note that in one example, each of these components can have an internal structure (e.g., a processor, a memory element, etc.) to facilitate some of the operations described herein. In other embodiments, these brokerage activities may be executed externally to these components, or included in some other component to achieve this intended functionality. Alternatively, the components of communication system 10 may include this software (or reciprocating software) that can coordinate with other components in order to achieve the operations, as outlined herein. In still other embodiments, one or several components may include any suitable algorithms, hardware, software, firmware, elements, modules, interfaces, or objects that facilitate the operations thereof.

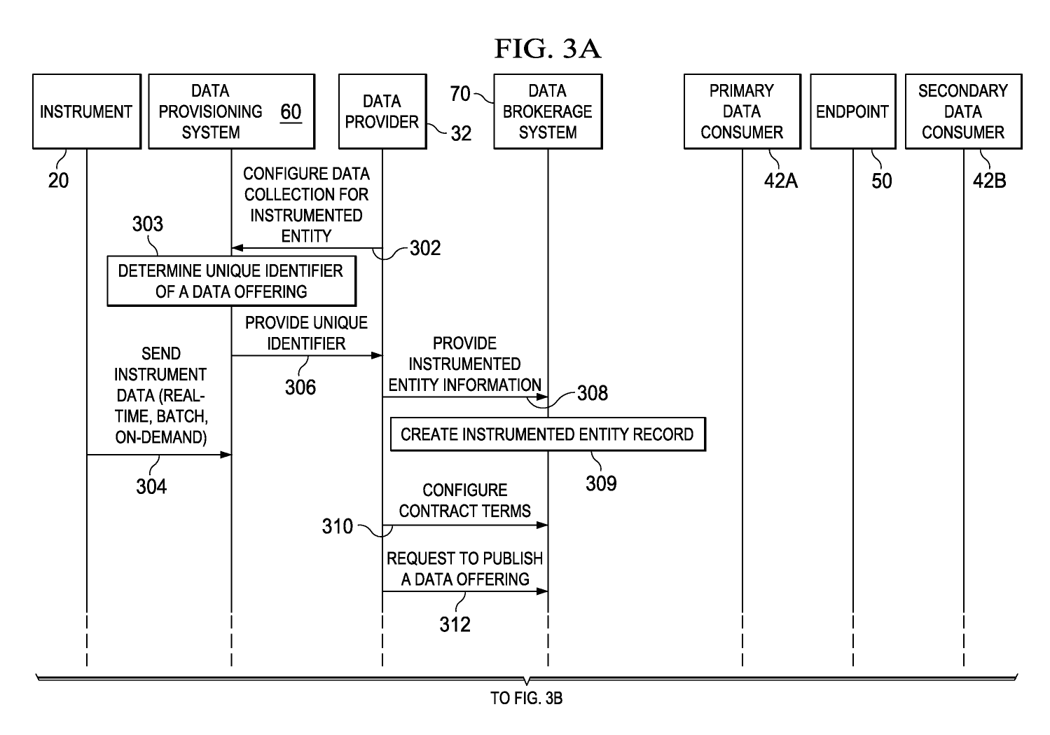

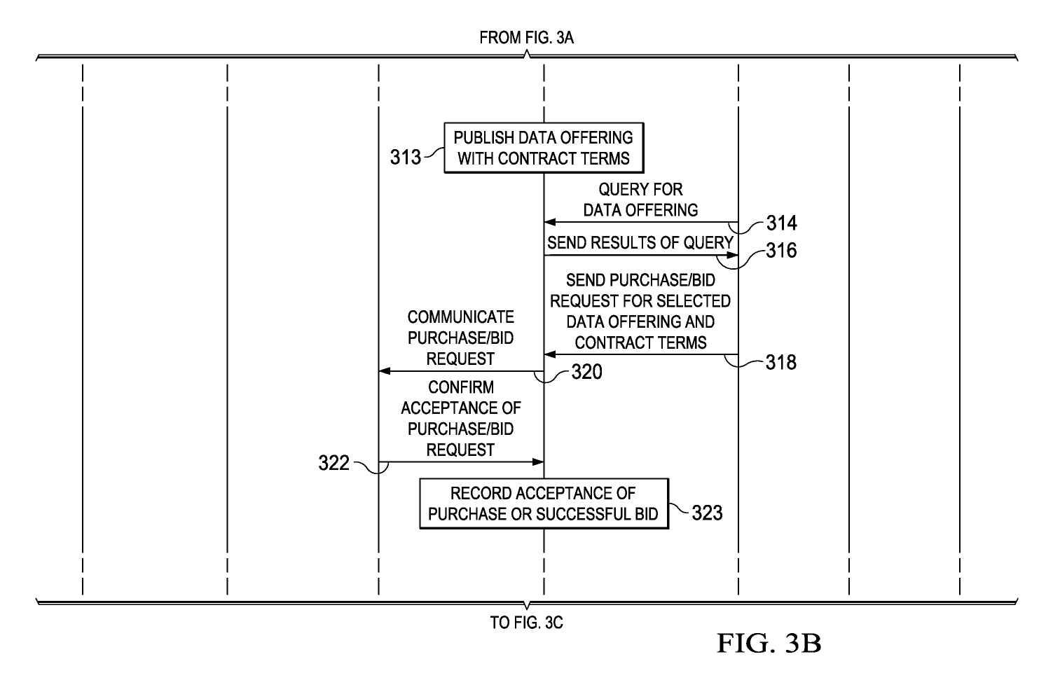

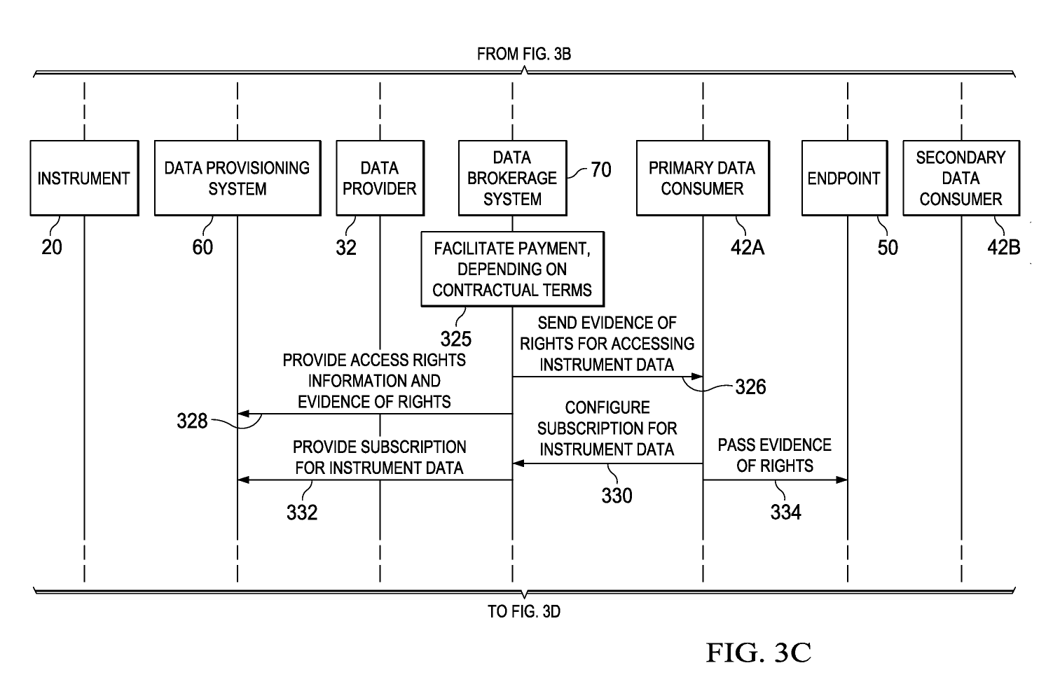

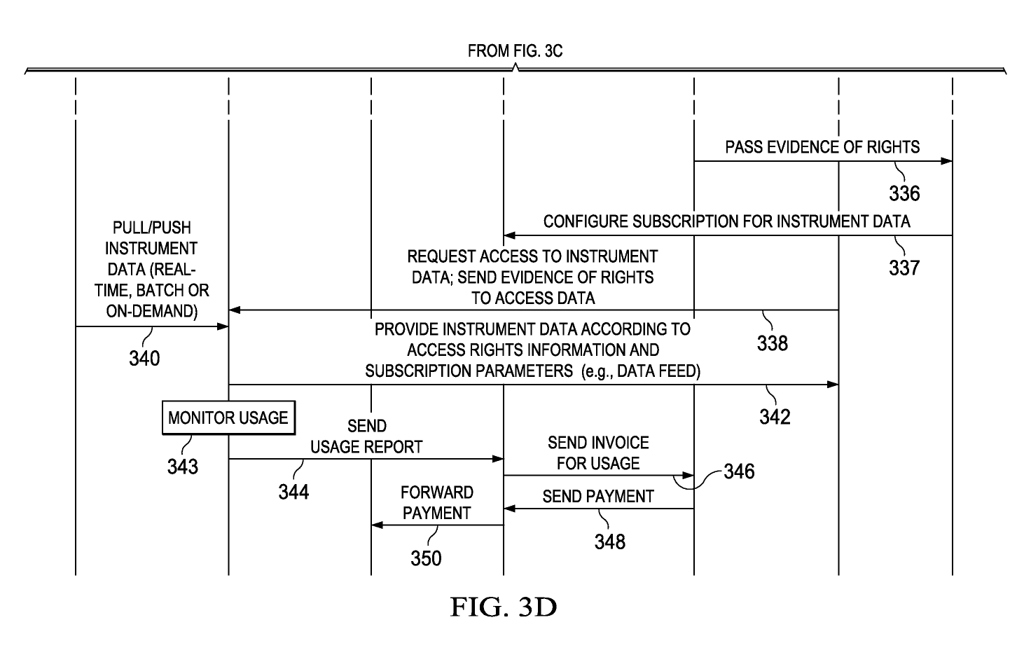

Turning to FIGS. 3A-3D, a simplified interaction diagram illustrates possible interactions that may occur in communication system 10 between instrument 20, data provider 32, primary data consumer 42A, secondary data consumer 42B, endpoint 50, data provisioning system 60, and data brokerage system 70. Data provider 32, primary data consumer 42A, and secondary data consumer 42B are shown in FIGS. 3A-3D for ease of explanation, and are intended to represent human users, each interacting with a computing system or device capable of initiating network communications with other network elements and computing systems. Data provider 32 and primary data consumer 42A may use the same computing systems for all interactions (e.g., data provider system 30, primary data consumer systems 40A). Alternatively, the human users could employ different devices or computing systems to communicate with data brokerage system 70 and other components. For example, primary data consumer 42A may use a laptop to search for data offerings and may then use a mobile device to submit a bid or purchase request for access rights. It should be noted, however, that primary data consumer 42A is assumed to be interacting with (or to have enabled communication with) primary data consumer system 40A when the evidence of rights is received from data brokerage system 70 after access rights have been purchased. It is further assumed that primary data consumer system 40A is configured with access rights module 44A to enable passing the evidence of rights to other systems (e.g., endpoint 50, secondary data consumer system 40B) and possibly enabling the distribution of access rights to secondary data consumers (e.g., secondary data consumer 42B).

Certain modules of various computing systems may perform the interactions and activities described with reference to data provider 32 and data consumers 42A and 42B of FIGS. 3A-3D. In at least one embodiment, a browser of data provider system 30 (or a browser of another computing system or device used by data provider 30) could perform one or more interactions and activities associated with data provider 32. In at least one embodiment, browsers (not shown) and/or access rights modules 44A and 44B of respective data consumer systems 40A and 40B could perform one or more interactions and activities associated with data consumers 42A and 42B. In at least some scenarios, a browser of another computing system or device used by primary data consumer 42A could perform one or more interactions and activities associated with primary data consumer 42A.

Regarding the other components of FIGS. 3A-3D, in at least one embodiment, data communication module 22 could perform one or more interactions and activities associated with instrument 20; data access module 52 could perform one or more interactions and activities associated with endpoint 50; data collection module 62, authentication module 64, and/or data distribution module 66 could perform one or more interactions and activities associated with data provisioning system 60; and marketing module 72, contract management module 74, rights module 75, and/or billing module 76 could perform one or more interactions and activities associated with data brokerage system 70. The example of FIGS. 3A-3D are merely examples of potential interactions, and do not limit the scope of the claims. For example, number of modules may vary, number of components may vary, specific interactions may vary, order of interactions may vary, etc.

FIGS. 3A-3D illustrate an example scenario of a data provider 32 creating and publishing a data offering of instrument data generated by instrument 20 for instrumented entity 22. Primary data consumer 42A finds and purchases access rights to the instrument data, passes the evidence of rights to endpoint 50, and sells the access rights to secondary data consumer 42B. In addition, endpoint 50 accesses the instrument data and the data usage is monitored and billed back to primary data consumer 42A. Although separately shown and described in FIGS. 3A-3D, it should be appreciated that in some embodiments, data provisioning system 60 and data brokerage system 70 may be integrated and/or accessible as a an integrated service to data providers and data consumers.

In the example scenario of FIGS. 3A-3D, at 302, data provider 32 communicates with data provisioning system 60 to configure data collection from instrument 20. In at least one embodiment, data provider 32 can configure the data collection directly with data provisioning system 60 via, for example, a user interface provided by data provisioning system 60. In at least one other embodiment, data provider 32 may interact with data brokerage system 70, which can provide appropriate communications to data provisioning system 60 to enable the requested data collection configuration (e.g., collect data from instrument 20 in real-time, collect data from instrument 20 on-demand, etc.).

In at least one embodiment, data collection can be configured to receive instrument data using any desired granularity available from instrument 20. For example, instrument data generated by instrument 20 could include multiple data elements. Data collection by data provisioning system 60 can be configured to receive the instrument data based on any or all of the data elements separately or combined in any desired manner. For example, a water sensor in a drain may be capable of measuring water height, flow rate, clarity, toxicity, and temperature. In one example scenario, data provider 32 could configure a granular data collection of the water height, flow rate, and toxicity measurements individually, but not the clarity and temperature. In this scenario, data provider 32 may offer for sale access rights to water height, flow rate, toxicity, and/or any combination thereof. Thus, data provider 32 can market any or all of the instrument data generated by instrument 20, at any desired granularity, and may configure the data collection of the instrument data accordingly.

In at least some embodiments, at 303, data provisioning system 60 may determine a unique identifier for a data offering for access rights to instrument data generated by instrument 20. For example, the unique identifier of the data offering could be a network address or other unique identification associated with instrument 20. Thus, instrument 20 could provide the unique identifier to data provisioning system 60. In other scenarios, the unique identifier may be created by data provisioning system 60 or, possibly, by data brokerage system 70. In particular, when data provider 32 packages instrument data from multiple instruments into a single data offering (e.g., instrument 20 and other instruments), a unique identifier of a data offering can be generated by data provisioning system 60 or data brokerage system 70. If data provisioning system 60 determines or creates a unique identifier for a data offering, then at 306, data provisioning system 60 may provide the unique identifier to data provider 32. For ease of illustration and explanation, the scenario of FIGS. 3A-3D includes a single instrumented entity with a single instrument (i.e., instrumented entity 22 and instrument 20). Therefore, the data offering described with reference to FIGS. 3A-3D is created for access rights to instrument data generated only by instrument 20. It will be apparent, however, that in other scenarios, a data offering could be created for instrument data generated by multiple instruments packaged into a single data offering.

At some point in time, such as 304, after data collection has been configured for instrument data, instrument 20 may begin sending instrument data to data provisioning system 60. Depending on the configuration by data provider 32, the instrument data can be sent as a stream of real-time data (e.g., continuously or periodically), as batch updates (e.g. pre-selected times/days), or on-demand (e.g., when an endpoint with valid evidence of rights requests access to instrument data). In some instances, data collection by data provisioning system 60 may not begin until a data offering has been published, until access rights to the instrument data have been purchased, or until a valid evidence of rights has been presented to data provisioning system 60 by an endpoint.

At 308, instrumented entity information can be provided to data brokerage system 70 by data provider 32. Instrumented entity information can include attributes of instrumented entity 22, instrument 20, and/or instrument data being generated by instrument 20. The attributes can be used by data brokerage system 70 to create, at 309, an instrumented entity record. The record can contain one or more details of static and/or dynamic data associated with instrumented entity 22, instrument 20, and/or instrument data generated by instrument 20.

If a unique identifier of a data offering (for access rights to instrument data generated by instrument 20) was determined by data provisioning system 60, then the unique identifier can also be provided to data brokerage system 70. In some embodiments, data provider 32 could communicate the unique identifier to data brokerage system 70, along with the attributes, as part of the instrumented entity information. In other embodiments, data provisioning system 60 could send or share the unique identifier with data brokerage system 70. If data provisioning system 60 did not determine the unique identifier, then data brokerage system 70 may determine it after receiving the instrumented entity information.

At 310, data provider 32 can configure contract terms available for purchasing access rights to the instrument data. In one example, the contract terms could be configured as a single set of one or more non-negotiable contract terms for a data offering. In another example, multiple alternative sets of one or more contract terms could be configured for the data offering. In this scenario, a data consumer can purchase access rights associated with the data offering by selecting (and agreeing to abide by) any desired set of the multiple sets of contract terms. For example, a certain data offering could be published with one set of contract terms that include non-exclusive access rights with a per usage cost, and another set of contract terms that include exclusive access rights with a per usage cost in addition to a monthly minimum cost. A data consumer could select either one of the sets of contract terms presented with the data offering and request to purchase (or bid on) the access rights as indicated in the selected contract terms.

At 312, data provider 32 can request to publish a data offering for instrument data generated by instrument 20. The data offering can be created based on attributes in the record associated with instrumented entity 22, instrument 20, and/or instrument data being generated by instrument 20, and on contract terms configured for purchasing access rights to the available instrument data. In some embodiments, a data offering may allow certain contract terms to be configured or selected by a data consumer. These data offerings may not provide specific pricing until after the data consumer has configured or selected all of the required contract terms. For example, a data consumer may be able to select the contract period, particular data elements desired from the instrument data (e.g., only water height and flow rate of a drain sensor). At 313, data brokerage system 70 may publish the data offering including the contract terms and at least some attributes of the instrument data, instrument, and/or instrumented entity.

At 314, primary data consumer 42A may send a query to data brokerage system 70 for data offerings. The query may be configured to initiate searching or browsing data offerings of data brokerage system 70. Searching and browsing may be facilitated by marketing module 72 of data brokerage system to enable data consumers to discover desired data offerings. It should be apparent that searching and/or browsing could be performed using any suitable searching or browsing techniques. In at least one embodiment, data consumer 42A may select search key terms and/or make browsing selections that are related to attributes of instrumented entity 22, instrument 20, and/or the instrument data generated by instrument 20. At 316, data brokerage system 70 sends the results of the query back to primary data consumer 42A. The results could include one or more data offerings. Any number of additional queries could be performed including refined queries and/or new queries using different searching or browsing criteria.

Primary data consumer 42A can select one of the data offerings and desired contract terms presented with the data offering. In at least one embodiment, the contract terms could be selected from individual contract terms (e.g., degree of exclusivity, acceptable delay, distribution rights, number of users, contract period, specific data elements or combinations of data elements, etc.) or from multiple sets of bundled contract terms, which were configured for the data offering by data provider 32.

At 318, a purchase request for access rights of a selected data offering can be sent to data brokerage system 70. In a bidding scenario, additional communications may occur between data brokerage system 70 and primary data consumer 42A related to which bid is currently winning and possibly additional bids from primary data consumer 42A. These communications may continue during the time period allowed for bidding. Once the time period allowed for bidding has expired, data brokerage system 70 may communicate a notice to primary data consumer 42A as to whether primary data consumer 42A won the bid. The notice can be communicated when primary data consumer 42A accesses data brokerage system 70 via some computing system (e.g., primary data consumer system 40A or some other computing system). The notice may also be communicated to primary data consumer 42A using any other suitable communication mechanism including, but not limited to email and/or text message.

In some embodiments, optional communications at 320 and 322 may occur between data brokerage system 70 and data provider 32 when a purchase request has been received for the data offering created by data provider 32. At 320, data brokerage system 70 can communicate the purchase request to data provider 32. In at least one embodiment, the purchase request could be communicated to data provider 32 when data provider 32 establishes a network connection to data brokerage system 70. The purchase request could also be communicated using any other approved communication mechanism capable of communicating information to data provider 32 such as, for example, email, text messaging, push notifications on a mobile device, etc. At 322, data provider 32 can confirm (or deny) acceptance of the purchase request. If the purchase request is denied (e.g., if a bid is not successful), then data brokerage system 70 can communicate this denial to primary data consumer 42A.

In at least one embodiment certain contract terms may be configurable by primary data consumer 42A. In this scenario, at 320, data brokerage system 70 may communicate to data provider 32 the contract terms that were configured by primary data consumer 42A. At 322, data provider 32 may communicate specific pricing and/or costing basis based on the contract terms, or based on modified contract terms. Data brokerage system 70 may provide this information to primary data consumer 42A, which can be accepted or rejected. Any number of additional communications between primary data consumer 42A and data provider 32, via data brokerage system 70, may occur, for example, until primary data consumer 42A accepts the proposed pricing and other contract terms or discontinues the negotiations.

In some embodiments, the communications at 320 and 322 may be omitted, and data brokerage system 70 may be configured to accept a purchase request or successful bid without prior confirmation from the associated data provider. Data brokerage system 70 could also be configured to act as an agent of the associated data provider to negotiate different contract terms, including pricing, with primary data consumer 42A. In the example scenario illustrated in FIGS. 3A-3D, however, data provider 32 communicates, to data brokerage system 70, confirmation that the purchase request has been accepted. At 323, data brokerage system 70 records the acceptance of the purchase or successful bid for the data offering. This may include recording access rights information for the purchased access rights. In at least one embodiment, access rights information may be stored in access rights repository 86.

At 325, data brokerage system 70 may facilitate payment, from primary data consumer 42A to data provider 30. The payment can be dependent on the accepted contract terms. For example, the accepted contract terms could require an upfront payment or escrow option for the purchased access rights. In this scenario, for example, data brokerage system 70 could be configured to facilitate payment by providing payment options (e.g., credit card, bank draft, third-party payment option, etc.) to primary data consumer 42A, and requiring valid payment information to be provided prior to providing primary data consumer 42A with evidence of rights to access the instrument data (or prior to ‘activating’ the evidence of rights). In other scenarios, the accepted contract terms could require payment based on data usage, periodic minimum billing, or any other suitable arrangement. Therefore, payment may be facilitated by data brokerage system 70 at the appropriate time based on the accepted contract terms.

After a purchase or bid has been accepted for a data offering, data brokerage system 70 may generate evidence of rights for accessing the instrument data generated by instrument 20. In at least one example, the evidence of rights could be a unique coded token generated to represent the particular access rights that were purchased by primary data consumer 42A. In at least one other example, the evidence of rights could correspond to (or be equivalent to) the unique identifier assigned to the data offering associated with the purchased access rights. In one example implementation, the coded token or unique identifier could be stored in access rights repository 86 with access rights information that defines the purchased access rights, or could be mapped, linked, or otherwise associated with the access rights information.

At 326, data brokerage system 70 can send the evidence of rights to primary data consumer 42A. The evidence of rights may be received and stored on primary data consumer system 40A, or in another storage medium accessible to primary data consumer system 40A, to be used and/or passed to one or more endpoints according to accepted contract terms. The evidence of rights may also be passed to secondary data consumer system 40B when the access rights (represented by the evidence of rights) are transferred, sold, and/or otherwise distributed according to the accepted contract terms. In at least one other embodiment, primary data consumer 42A may provide, to data brokerage system 70, network communication information of endpoint 50 to enable data brokerage system 70 to send the evidence of rights directly to endpoint 50 (e.g., by accessing an IP address of endpoint 50, by transferring a file using File-Transfer-Protocol, by sending a short message service (SMS) communication, etc.).

In addition to providing evidence of rights to the primary data consumer that purchases access rights to the instrument data, network connection information may also be provided to enable an endpoint to establish a network connection to data provisioning system 60 to access the instrument data. For some access rights, however, an endpoint may be required to access the instrument data by communicating with an instrument directly. In this scenario, network connection information of the instrument may be provided to enable the endpoint to establish a network connection with the instrument. In at least one embodiment, the evidence of rights and connection information may be configured in access rights module 44A, which can be received and stored on primary data consumer system 40A.

At 328, data brokerage system 70 provides data provisioning system 60 with the evidence of rights (e.g., coded token), or information needed to validate the evidence of rights when presented by an endpoint. Data brokerage system 70 also provides data provisioning system 60 with access rights information related to the purchased access rights. Access rights information can include an identification of which instrument the evidence of rights covers (e.g., network address of instrument 20, unique identifier of data offering), limits on how much instrument data can be accessed by an endpoint, and any other contract terms that are needed to properly manage access requests for the instrument data. In some instances where access rights allow accessing instrument 20 directly, the access rights information and evidence of rights may be provided to, or otherwise made available to, instrument 20.

At 330, primary data consumer 42A can provide parameters to data brokerage system 70 in order to configure a subscription for accessing instrument data associated with the purchased access rights. In some embodiments, a subscription may be configured on the relevant instrument by providing parameters to the instrument. In another embodiment, subscriptions may be configured on data provisioning system 60 by providing parameters to the data provisioning system. The parameters of the subscription may specify, for example, the frequency of instrument data downloads possibly including specific times of the day/week/month/etc., specific data elements to be downloaded, amount of data to be downloaded, subscription period, etc. These parameters may be configured in order to maximize utility, while minimizing data volume. In at least one embodiment, the user-configured subscription parameters may be stored in subscription repository 88, and can be mapped, linked, or otherwise associated with the evidence of rights (and/or with the associated access rights information).

At 332, data brokerage system 70 can provide the subscription parameters to data provisioning system 60. Accordingly, when an endpoint presents the evidence of rights to data provisioning system 60, the instrument data associated with the purchased access rights can be identified and provided to the endpoint according to the access rights and the subscription parameters. If the access rights allow direct access to instrument 20, data brokerage system 70 may provide, or otherwise make available, the subscription parameters to instrument 20. Instrument 20 can then provide instrument data to an endpoint according to the access rights information and the subscription parameters.

It will be apparent that communicating access rights information, evidence of rights, and subscription parameters to data provisioning system 60 (or instrument 20 when accessed directly) could be implemented in various ways. For example, in some implementations, evidence of rights, access rights, subscription parameters, or any combination thereof may be integrated or combined and provided to data provisioning system 60 (or to instrument 20 when accessed directly). In other examples, subscriptions may be configured by a data consumer through data provisioning system 60 or instrument 20, without necessarily involving data brokerage system 70. In these implementations, the subscription parameters, if any, are already known to the data provisioning system or instrument where the subscription was configured.

In at least one embodiment, once data provisioning system 60 receives the subscription parameters and access rights information for the instrument data of instrument 20, data provisioning system 60 may collect instrument data from instrument 20 (e.g., by pull or push techniques) according to the access rights information and the parameters of the subscription. For example, if the access rights are exclusive and the subscription parameters limit data consumption to two specific data elements in real-time, then data provisioning system 60 may only collect (e.g., by pull or push techniques) the two specific data elements in real-time. In another example, if the subscription parameters allow all of the data elements to be consumed by an endpoint on-demand, then data provisioning system 60 may only collect the instrument data when a valid evidence of rights is presented from an endpoint. In yet another example, if multiple data consumers have access rights and possibly subscriptions to the same instrument data, then data provisioning system 60 may collect the instrument data in an amount and frequency to satisfy all of the access rights and subscriptions associated with the instrument data.

At 334, primary data consumer 42A can pass evidence of rights (e.g., coded token), stored on primary data consumer system 40A, to endpoint 50 and possibly other endpoints if the contract terms allow multiple endpoints. In some instances, primary data consumer system 40A may serve as an endpoint for accessing the instrument data. If the contract terms allow the access rights to be distributed to a secondary data consumer, then at 336, primary data consumer 42A may transfer, sell, or otherwise distribute the access rights to secondary data consumer 42B by passing the evidence of rights to secondary data consumer system 40B. Other transactions may also occur between primary data consumer 42A and secondary data consumer 42B to effect the sale, transfer, or other distribution of the access rights (e.g., payment transaction). Although not shown in FIGS. 3A-3D, the evidence of rights may also be passed to one or more other endpoints associated with secondary data consumer 42B to enable access to the instrument data via the other endpoints. Furthermore, in some scenarios, secondary data consumer system 40B may serve as an endpoint for accessing the instrument data. The evidence of rights may be passed (e.g., to endpoint 50, to secondary data consumer system 40B) using any suitable network connection or data transfer techniques. Furthermore, evidence of rights may be passed using other suitable techniques including, but not limited to, manual entry or access to a data storage device containing the evidence of rights (e.g., Universal Serial Bus (USB) flash drive, digital versatile disc (DVD), compact disc (CD), etc.).

At 337, secondary data consumer 42B can provide parameters to data brokerage system 70 to configure a subscription for accessing instrument data associated with the evidence of rights received from primary data consumer 42A. In at least some embodiments, secondary data consumer 42B can provide parameters directly to instrument 20 to configure a subscription. In at least some embodiments, secondary data consumer 42B can provide parameters to data provisioning system 60 to configure a subscription. The subscription configured by secondary data consumer 42B can be applied to instrument data requested by an endpoint that presents the evidence of rights, when the endpoint is associated with secondary data consumer 42B. However, the subscription may not be applied to instrument data requested by an endpoint that presents the evidence of rights, when the endpoint is associated with primary data consumer 42A or with other secondary data consumers.

In some scenarios, the access rights may not be exclusive, and primary data consumer 42A may retain the right to further use and/or distribute the access rights. For example, primary data consumer 42A may continue to use the evidence of rights, possibly with its own subscription, to access instrument data from one or more endpoints. In these instances, the evidence of rights used by endpoints of each distinct data consumer (e.g., endpoints of primary data consumer 42A, endpoints of secondary data consumer 42B) may be distinguished in any suitable manner. For example, if the evidence of rights is a coded token, the coded token could be modified for each secondary data consumer to whom the access rights are distributed. In another example, when requesting instrument data the evidence of rights could be presented along with a unique identifier of the particular endpoint and/or data consumer system. It will be apparent that any number of other approaches could be implemented to distinguish multiple instances of evidence of rights when the evidence of rights is distributed to any other data consumer systems.

At 338, endpoint 50 may send a request to data provisioning system 60 for access to the instrument data. Endpoint 50 can also send evidence of rights to data provisioning system 60. Data provisioning system 60 can determine whether the evidence of rights is valid using any suitable validation techniques. If the evidence of rights is valid, data provisioning system 60 can determine which instrument data is to be accessed, specific access rights that were purchased, and subscription parameters, if any, based on the evidence of rights presented by endpoint 50. In some scenarios, the purchased access rights can require endpoint 50 to access instrument 20 directly to obtain the instrument data. In this case, endpoint 50 can send to instrument 20, the evidence of rights and a request for access to the instrument data. Therefore, data provisioning system 60 can be bypassed in communications between endpoint 50 and instrument 20.

At 340, data provisioning system 60 may pull data, if needed (e.g., for on-demand access rights), from instrument 20 to satisfy the request from endpoint 50. In other scenarios, instrument 20 may push instrument data in real-time or by batch updates to data provisioning system 60. Pushing and/or pulling data in real-time may occur continuously (e.g., for each instance of generated instrument data), continuously for selected periods of time, or whenever requested by data provisioning system 60. Pushing and/or pulling data in batch updates may occur at selected times and may include any or all data since the last batch update. These examples are provided for illustrative purposes only, and it will be apparent that instrument data could be provided to data provisioning system 60 using any suitable techniques and/or timing to accommodate the purchased access rights and subscription, if any.

Once data provisioning system 60 (or instrument 20) has received the request for access to instrument data and valid evidence of rights, at 342, a data feed may be established between data provisioning system 60 (or instrument 20) and endpoint 50 to transfer, push, pull, send, transmit, or otherwise communicate the requested instrument data to endpoint 50. The data feed of instrument data can be established according to the access rights information and subscription parameters, if any. When endpoint 50 receives the instrument data, endpoint 50 can provide data access to primary data consumer 42A (e.g., raw data or analyzed data, or integrated with a service).

Similarly, data provisioning system 60 (or instrument 20) can establish a data feed to another endpoint associated with secondary data consumer 42B, if the other endpoint requests access to the instrument data and provides the evidence of rights representing access rights purchased or otherwise obtained from primary data consumer 42A. The data feed of instrument data can be established according to access rights information and also subscription parameters, if a subscription has been configured to access the instrument data by endpoints that are associated with secondary data consumer 42B. When the other endpoint receives the instrument data, the other endpoint can provide data access to secondary data consumer 42B (e.g., raw data or analyzed data, or integrated with a service).

If the contract terms of the purchased access rights specify a data usage costing basis, then the remaining interactions and communications of FIG. 3D could enable billing based on the specified costing basis (e.g., per megabyte, period, number of endpoints, etc). At 343, data provisioning system 60 can monitor instrument data usage according to the costing basis in the accepted contract terms. In at least one embodiment, the instrument data usage is the amount of instrument data that is accessed (e.g., downloaded to, transferred to, sent to, pushed to, pulled by, etc.) an endpoint with valid access rights. At 344, data provisioning system 60 may send a usage report to data brokerage system 70. If the endpoints bypass data provisioning system 60 and access instrument 20 directly, then instrument 20 may monitor data usage and send a usage report to data brokerage system 70.

At 346, data brokerage system 70 can send an invoice to primary data consumer 42A, according to the costing basis. The invoice can be sent via any communication mechanism capable of communicating information to primary data consumer 42A (e.g., email, text message, push notification on a mobile device, paper mail, etc.). In addition, the invoice can be accessed via any computing system capable of network communications to access an account created for primary data consumer 42A on data brokerage system 70 (or some other system associated with billing). At 348, payment may be sent to data brokerage system 70. Any computing system and/or financial institution associated with primary data consumer 42A may be used to send payment to data brokerage system 70. Furthermore, primary data consumer 42A may configure the payment method to enable data brokerage system 70 to automatically withdraw payment from any financial institution or payment provider (e.g., credit card, third party payment provider, etc.). At 350, data brokerage system 70 may forward the payment to any financial institution approved by data provider 32 or directly to data provider 32 (e.g., by check). The financial institution information may be mapped, linked, or otherwise associated with the record for instrumented entity 22 created in data brokerage system 70.

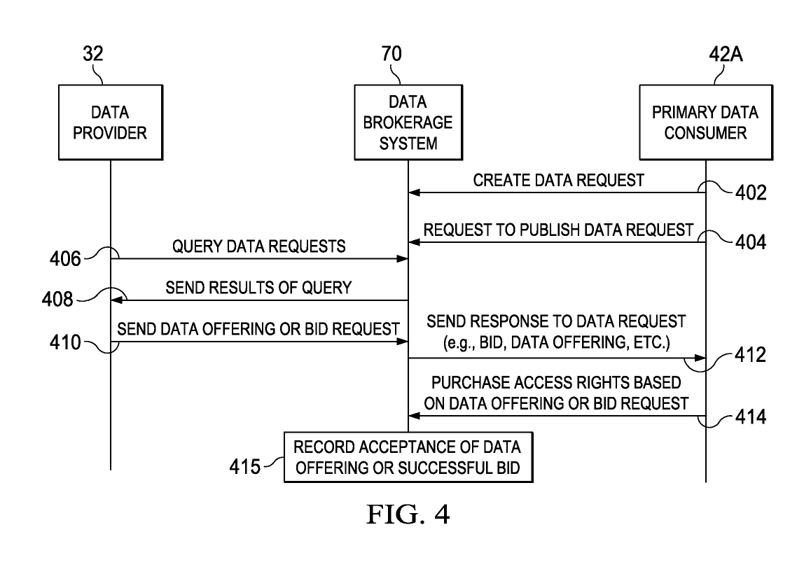

Turning to FIG. 4, a simplified interaction diagram illustrates possible interactions that may occur in communication system 10 between data provider 32, data brokerage system 70, and primary data consumer 42A. Data provider 32 and primary data consumer 42A are shown in FIG. 4 for ease of explanation, and are intended to represent human users, each interacting with a computing system or device capable of initiating network communications with data brokerage system 70. The human users may use the same computing systems for all interactions (e.g., data provider system 30, primary data consumer system 40A). Alternatively, the human users could employ different devices or computing systems to communicate with data brokerage system 70 and other components. For example, primary data consumer 42A may use a home desktop to create and publish a data request, and then later use a mobile device to purchase access rights. It should be noted, however, that primary data consumer 42A is assumed to be interacting with (or to have enabled communication with) primary data consumer system 40A when the evidence of rights is received from data brokerage system 70 after access rights have been purchased. It is further assumed that primary data consumer system 40A is configured with access rights module 44A to enable passing the evidence of rights to other systems (e.g., endpoint 50, secondary data consumer system 40B) and possibly enabling the distribution of access rights to secondary data consumers.

Certain modules of the components of FIG. 4 may perform the various interactions and activities described with reference to FIG. 4. In at least one embodiment, a browser of data provider system 30 (or a browser of another system or device used by data provider 32) could perform one or more interactions and activities associated with data provider 32; a browser of primary data consumer system 40A (or a browser of another system or device used by primary data consumer 42A) could perform one or more interactions and activities associated with primary data consumer 42A; and marketing module 72, contract management module 74, rights module 75, and/or billing module 76 could perform one or more interactions and activities associated with data brokerage system 70. The example of FIG. 4 is merely an example of potential interactions, and does not limit the scope of the claims. For example, number of modules may vary, number of components may vary, specific interactions may vary, order of interactions may vary, etc.

FIG. 4 illustrates an example scenario of a primary data consumer 42A advertising a data request through data brokerage system 70. Data provider 32 searches/browses and finds the data request, which may be satisfied by instrument data provided by instrument 20. Data provider 32 bids on the data request or submits a data offering to primary data consumer 42A.

With reference to particular interactions in FIG. 4, at 402, primary data consumer 42A may create a data request on data brokerage system 70. The data request may be created with one or more attributes associated with desired instrument data, instruments, and/or instrumented entities. For example, attributes could include static data that is descriptive of a desired instrumented entity and/or instrument. Such attributes could include one or more of entity type(s), entity location(s), entity owner(s), instrument type(s), instrument location(s), instrument maker(s), number of sensors, etc. In one illustrative example, a data request could specify entity type and location: parking garage spaces in Chicago, Ill. Attributes in a data request could also narrow down particular instrument data that is desired by including details of dynamic data such as size (e.g., bytes per time period), frequency (e.g., how often the instrument data is produced and/or sent), data elements, data format, delay tolerance, accuracy tolerance, precision tolerance, etc. In yet further scenarios, primary data consumer 42A could configure contract terms desired for purchasing access rights to instrument data. Once the data request is created, at 404, primary data consumer 42A could send a request to publish the data request. Data brokerage system 70 can publish the data request by making it available to searching and browsing activities by data providers, for example.

At 406, data provider 32 may query data brokerage system 70 for data requests. The query may be configured to search and/or browse published data requests. Searching and browsing may be facilitated by data brokerage system 70 using marketing module 72 to enable data providers to select search key terms or browsing criteria to discover relevant published data requests. In one example, data provider 32 may use key terms and browsing criteria related to attributes of an instrumented entity, an instrument, and/or the generated instrument data owned (or otherwise controlled or managed) by data provider 32. Thus, data provider 32 can identify data requests that the data provider may be capable of fulfilling with their available instrument data. It should be apparent that searching and browsing could be performed using any appropriate searching techniques.

At 408, data brokerage system 70 sends the results of the query back to data provider 32. The results could include zero or more data requests. Any number of additional queries could be performed including refined queries and/or new queries using different search criteria or browsing selections. In this example illustration, it is assumed that the results of the query include the data request published by primary data consumer 42A at 404. It is also assumed that instrumented entity 22 with instrument 20 are owned/controlled by data provider 32, and the associated instrument data could satisfy the data request published by primary data consumer 42A.

Data provider 32 can respond to any data request listed in the results. The response could be, for example, in the form of a data offering or bid request, depending on the type of data request published by the selected data request (e.g., auction, negotiable purchase, non-negotiable purchase, etc.). In this example scenario, data provider 32 selects the published data request of primary data consumer 42A, and at 410, data provider 32 provides a data offering or a bid request in response to the published data request. In at least one embodiment, a data offering may be provided when the published data request does not specify contract terms for the requested data. By way of example, the published data request could specify instrument data for parking garage spaces in Chicago, Ill. Accordingly, data provider 32 could create a data offering on data brokerage system 70 to be communicated to primary data consumer 42A at 412. The data offering could be accepted, rejected, or possibly negotiated by primary data consumer 42A.

In at least one other example, a bid request may be provided when the published data request specifies desired contract terms. By way of example, the published data request could specify instrument data from parking garage space sensors in Chicago, Ill., non-exclusive rights, delay tolerance=30 sec maximum, 2 users, and no distribution rights. Costing basis and or a maximum bid amount may also be specified. Accordingly, a bid request specifying a bid amount could be provided to data brokerage system at 410, and then communicated to primary data consumer 42A at 412. The bid request could indicate data provider 32's willingness to accept the specified contract terms if the bid request is accepted.

In a bidding scenario, additional communications may occur between data brokerage system 70 and data provider 32 related to which bid is currently winning and possibly additional bid requests from data provider 32. These communications may continue during the time period allowed for bidding. Once the time period allowed for bidding has expired, data brokerage system 70 may communicate a notice to data provider 32 as to whether data provider 32 won the bid. The notice can be communicated when data provider 30 accesses data brokerage system 70 via some computing system (e.g., data provider system 30 or some other device or computing system). The notice may also be communicated to data provider 32 using any other suitable communication mechanism including, but not limited to email and/or text message.

At 414, primary data consumer 42A can purchase access rights based on the data offering or bid request from data provider 32. At 415, data brokerage system 70 can record the purchase and indicate whether the purchase resulted from a data offering or successful bid. Additional interactions as previously described with reference to FIGS. 3A-3D may also occur in conjunction with the scenario presented in FIG. 4. For example, other interactions and activities that may be performed include, but are not limited to, creating evidence of rights, passing evidence of rights to an endpoint, using the evidence of rights to gain access to instrument data, distributing access rights to other data consumers such as secondary data consumer 42B, and facilitating billing associated with the purchase of access rights.

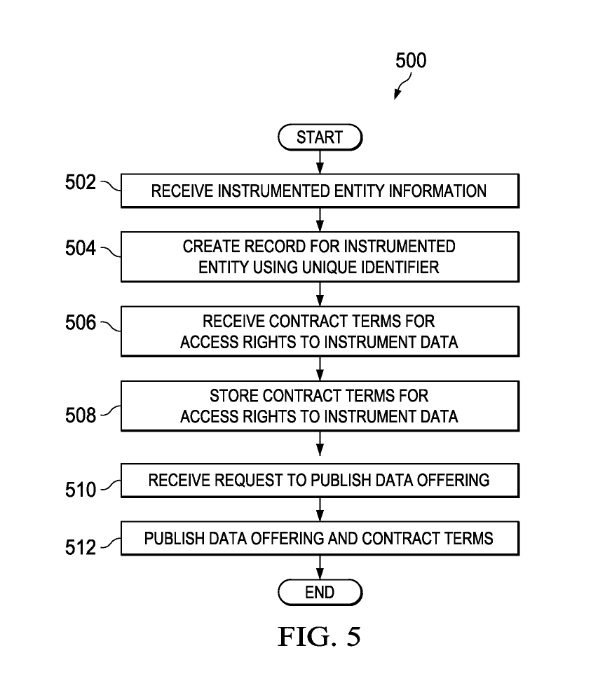

FIG. 5 is a simplified flowchart illustrating a potential flow 500 of operations that may be associated with embodiments described herein. In at least one embodiment, one or more sets of operations correspond to activities of FIG. 5. Data brokerage system 70, or a portion thereof, may utilize the one or more sets of operations. Data brokerage system 70 may comprise means such as one or more processors (e.g., processor 78), for performing the operations. In an embodiment, at least some operations of flow 500 may be performed by a marketing module (e.g., 72) and at least some other operations of flow 500 may be performed by a contract management module (e.g., 74).

Flow 500 illustrates at least one embodiment according to the present disclosure in which a data brokerage system 70 enables data provider 32 to advertise for sale (or auction) real-time and/or static data of an instrument (e.g., instrument 20 of instrumented entity 22). Flow 500 may begin at 502, where data brokerage system 70 determines instrumented entity information for a particular instrument. In at least one embodiment, data brokerage system 70 receives the instrumented entity information from data provider 32. Data provider may communicate with data brokerage system 70 using any suitable computing system, such as data provider computing system 30. A unique identifier of a data offering (to be created) for access rights to the instrument data of instrument 20 may also be determined by data brokerage system 70. In one embodiment, data brokerage system 70 receives the unique identifier from data provider 32. In other embodiments, data provisioning system 60 or instrument 20 may provide the unique identifier to data brokerage system 70, or data brokerage system 70 may create the unique identifier itself. The instrumented entity information can also include attributes of instrumented entity 22, instrument 20, and the instrument data being generated by instrument 20. At 504, data brokerage system 70 may create a record for instrumented entity 22 using the attributes received from data provider 32. In at least one embodiment, the record can be stored in instrumented entity information repository 81.

At 506, data brokerage system 70 determines contract terms available for purchasing access rights to instrument data generated by instrument 20. In at least one embodiment data brokerage system 70 receives the contract terms from data provider 32. In addition, multiple alternative sets of contract terms may be configured. At 508, data brokerage system 70 can store the contract terms, for example, in contract terms repository 85.

A data offering for access rights to instrument data generated by instrument 20 can be created by data brokerage system 70 based on attributes in the record created for instrumented entity 22, and on contract terms configured for access rights to the instrument data. At 510, data brokerage system 70 receives a request to publish the data offering. The request may identify the data offering by the unique identifier, or by any other suitable identification. At 512, data brokerage system 70 publishes the data offering with the contract terms and at least one attribute of the instrument data, the instrument, and/or the instrumented entity. Publishing the data offering includes making the data offering available to searching and browsing activities. In at least one embodiment, the data offering may be published with all of the attributes, and thus, data consumers could search for desired instrument data using any one of the possible attributes or any desired combination of the attributes.

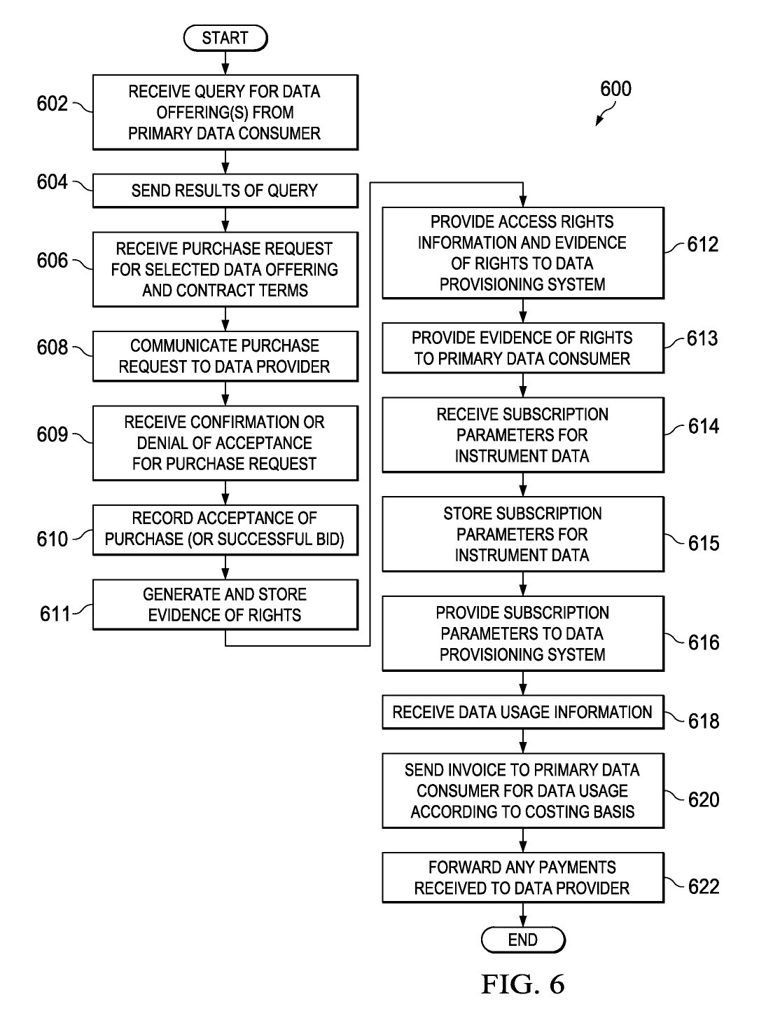

FIG. 6 is a simplified flowchart illustrating a potential flow 600 of operations that may be associated with embodiments described herein. In at least one embodiment, one or more sets of operations correspond to activities of FIG. 6. Data brokerage system 70, or a portion thereof, may utilize the one or more sets of operations. Data brokerage system 70 may comprise means such as one or more processors (e.g., processor 78), for performing the operations. In an embodiment, at least some operations of flow 600 may be performed by a rights module (e.g., 75) and at least some other operations of flow 600 may be performed by a billing module (e.g., 76).

Flow 600 illustrates at least one embodiment according to the present disclosure in which a data brokerage system 70 enables data consumer 42A to search/browse for data offerings, purchase or bid on a selected data offering with selected contract terms, configure a subscription for instrument data identified by the selected data offering, and generate evidence of rights to access instrument data identified by the selected data offering, and distribute the access rights. Flow 600 also illustrates at least one embodiment in which data brokerage system 70 facilitates payment from primary data consumer 42A to data provider 32 according to usage based costing. Data provider 32 and primary data consumer system 42A may communicate with data brokerage system 70 using any suitable computing system, such as data provider computing system 30 and primary data consumer system 40A, respectively, and possibly other computing systems.

Flow 600 may begin at 602, where data brokerage system 70 receives a query for data offerings from primary data consumer 42A. The query may be configured to initiate searching or browsing operations for data offerings on data brokerage system 70. In at least one example, search key terms (or browsing selections) that are included in query may be related to attributes of instrumented entity 22, instrument 20, and/or the instrument data generated by instrument 20. For ease of explanation, it is assumed that the results of the query include a data offering for instrument data generated by instrument 20 of instrumented entity 22. At 604, the query results may be sent to primary data consumer 42A. In some scenarios, additional queries and/or refined queries may be received by data brokerage system 70 from primary data consumer 42A.

At 606, data brokerage system 70 receives from primary data consumer 42A a purchase request for a selected data offering and contract terms. For ease of explanation, it will be assumed that the purchase request or bid request is provided for the data offering for instrument data of instrumented entity 22. In one scenario, primary data consumer 42A could have selected a desired set of contract terms from multiple alternative sets of contract terms presented with the data offering. In another scenario, the contract terms could have been fixed and non-negotiable. In yet another scenario, the contract terms could have been negotiated between data brokerage system 70 (as an agent of data provider 32) and primary data consumer 42A prior to primary data consumer 42A sending the purchase request to data brokerage system 70.

Optionally, at 608, data brokerage system 70 could communicate the purchase request to data provider 32 via any computing system (e.g., data provider system 30) and/or communication mechanism capable of communicating information to data provider 32 (e.g., email, text messaging, push notifications to a mobile device, etc.). At 609, data brokerage system 70 receives from data provider 32 a confirmation or denial of the purchase request. If a denial is received (e.g., bid was not successful), the purchase request is not accepted and the flow may end. In at least one embodiment, however, if the data offering permits negotiation of the contract terms, the denial may be accompanied by a counteroffer proposing different contract terms, which can be communicated to primary data consumer 42A. Thus, in this scenario, data brokerage system 70 may receive another purchase request from primary data consumer 42A based on new contract terms. If a confirmation to a purchase request is received at 609, then the remaining operations of flow 600 may be performed. In some embodiments, the operations described with reference to 608 and 609 may be omitted, and data brokerage system 70 may be configured to accept a purchase request without prior confirmation from data provider 32.

At 610, data brokerage system 70 records the acceptance of the purchase or successful bid for the data offering. Access rights information associated with the purchased access rights may also be recorded. Data brokerage system 70 may facilitate payment from primary data consumer 42A to data provider 32 at the appropriate time based on the accepted contract terms of the data offering. For example, payment may be facilitated immediately when the contract terms require an upfront payment, a one-time payment, or an escrow option for the purchased access rights.

At 611, data brokerage system 70 generates evidence of rights to access instrument data generated by instrument 20 of instrumented entity 22. Evidence of rights may be stored in access rights repository 86 and mapped, linked or otherwise associated with access rights information that defines the purchased access rights. In at least one embodiment, the evidence of rights may be a unique coded token representing the access rights purchased by primary data consumer 42A. At 612, data brokerage system 70 provides to data provisioning system 60 the access rights information (e.g., identification of instrument 20, one or more contract terms). In addition, the evidence of rights, or information needed to validate the evidence of rights when presented by an endpoint, may also be provided to data provisioning system 60. In some scenarios where access rights enable accessing the instrument data directly from instrument 20, data brokerage system 70 can provide the access rights information and evidence of rights (or information needed to validate the evidence of rights) to instrument 20. At 613, data brokerage system 70 sends the evidence of rights to primary data consumer 42A. The evidence of rights may be received and stored on primary data consumer system 40A. Primary data consumer 42A can manage the evidence of rights according to the accepted contract terms.

At 614, data brokerage system 70 determines subscription parameters from primary data consumer 42A for receiving the instrument data associated with the purchased access rights. Parameters of the subscription may specify, for example, the frequency of instrument data downloads, specific data elements to be downloaded, amount of data to be downloaded, subscription period, etc. In at least some cases, a subscription is used to maximize utility, and minimize data volume due to the enormous amount of real-time data that can potentially be generated. At 615, data brokerage system 70 also stores the user-configured subscription parameters, for example, in subscription repository 88. The subscription parameters may be mapped, linked, or otherwise associated with the evidence of rights and/or the access rights information.

At 616, data provider system 70 provides the subscription parameters, configured by primary data consumer 42A, to data provisioning system 60. In some scenarios where access rights enable accessing the instrument data directly from instrument 20, data brokerage system 70 can provide the subscription parameters to instrument 20. In other embodiments, the subscription may be configured through data provisioning system 60 or the instrument itself, rather than data brokerage system 70. When data provisioning system 60 (or instrument 20) can validate the evidence of rights, access the access rights information associated with the purchased access rights, and access any subscription parameters associated with the evidence of rights, then data provisioning system 60 (or instrument 20) can provide real-time and/or static instrument data to an endpoint when the endpoint requests the instrument data and presents the evidence of rights.

At 618, data brokerage system 70 receives data usage information from data provisioning system 60 (or instrument 20) if the accepted contract terms specify a data usage costing basis. The data usage information can provide the amount of data used for the specified costing basis. For example, when the costing basis is per megabyte′, the amount of data usage in megabytes may be reported when a threshold number of megabytes has been reached. In another example, when the costing basis is ‘per period’, the amount of data usage in megabytes (or other measurement unit) may be reported for the specified periods (e.g., weekly, monthly, quarterly, etc.). In yet another example, when the costing basis is per number of endpoint′, the amount of data usage may be reported based on the data usage for each of the endpoints that accessed instrument data with the associated evidence of rights during the relevant billing period.

At 620, data brokerage system 70 can send an invoice to primary data consumer 42A for data usage according to the specified costing basis. The invoice can be provided to primary data consumer 42A when primary data consumer 42A logs into an account of data brokerage system 70, or another system associated with the billing. The invoice could also or alternatively be sent to primary data consumer 42A by other communication mechanisms including, but not limited to email, text message, push notifications on a mobile phone, and/or paper mail. When payment is received by data brokerage system 70, at 622, the payment can be forwarded to data provider 32 using any financial institution approved by data provider 32.

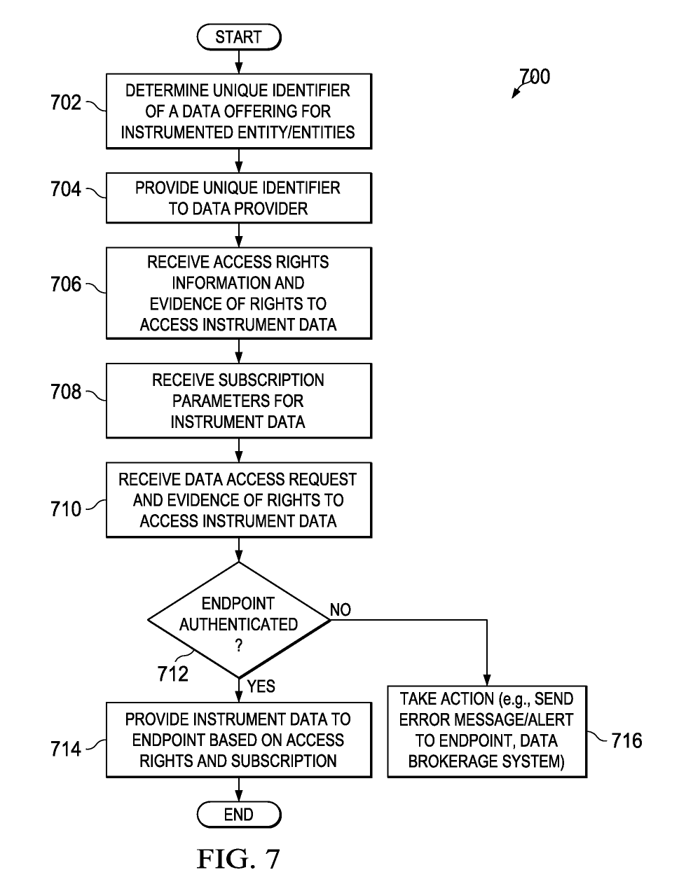

FIG. 7 is a simplified flowchart illustrating a potential flow 700 of operations that may be associated with embodiments described herein. In at least one embodiment, one or more sets of operations correspond to activities of FIG. 7. Data provisioning system 60, or a portion thereof, may utilize the one or more sets of operations. Data provisioning system 60 may comprise means such as one or more processors (e.g., processor 68), for performing the operations. In an embodiment, at least some operations of flow 700 may be performed by one or more of a data collection module (e.g., 62), an authentication module (e.g., 64), and a data distribution module (e.g., 66). Data provider 32 may communicate with data provisioning system 60 using any suitable computing system, such as data provider computing system 30.

Flow 700 illustrates at least one embodiment according to the present disclosure in which data provisioning system 60 collects instrument data from an instrument, such as instrument 20, and provides the instrument data to an endpoint that presents valid evidence of rights. Flow 700 may begin at 702, where data provisioning system 60 determines a unique identifier for a data offering for access rights to instrument data generated by a particular instrument (or by multiple instruments). At 704, data provisioning system 60 may provide the unique identifier to data provider 32. In at least one embodiment, the unique identifier may be mapped to the particular instrument (or to each of the multiple instruments when the instrument data of the multiple instruments is packaged into one data offering). The unique identifier may also be mapped to instrument data that is collected from the particular instrument (or multiple instruments) by data provisioning system 60, and that is to be fed to any endpoint that requests the instrument data and presents valid evidence of rights.

At 706, data provisioning system 60 receives from data brokerage system 70 evidence of rights for accessing the instrument data of instrument 20. Data provisioning system 60 also receives access rights information related to the access rights that were purchased by primary data consumer 42A for the instrument data. The access rights information can include an identification of which instrument the evidence of rights covers (e.g., network address of instrument, unique identifier of data offering), and any of the accepted contract terms needed to manage access to the instrument data, including any limits on how much and when instrument data can be accessed by an endpoint.

At 708, data provisioning system 60 may receive subscription parameters for the instrument data, if any have been configured. These subscription parameters may be received from data brokerage system 70. In at least one other embodiment, subscriptions may actually be configured via data provisioning system 60 when access rights have been purchased and primary data consumer 42A can provide evidence of rights to data provisioning system 60. The subscription parameters can include parameters that were configured by primary data consumer 42A after purchasing access right to the instrument data. Any subscription parameters (e.g., frequency of instrument data downloads, specific data elements to be downloaded, amount of data to be downloaded, subscription period, etc.) can be mapped or otherwise associated with the evidence of rights.

At 710, data provisioning system 60 receives a request for the instrument data from an endpoint, such as endpoint 50. The request can include evidence of rights. At 712, a determination is made as to whether the evidence of rights presented in the request is valid. Any suitable validation techniques may be used (e.g., asymmetric key cryptography, symmetric key cryptography, etc.) Thus, it should be apparent that the evidence of rights presented in the request may be a representation of the original evidence of rights generated by data brokerage system 70 (e.g., an encrypted version of the original evidence of rights). If it is determined that the evidence of rights is not valid, then endpoint 50 is not authenticated and is blocked from accessing the instrument data. Thus, at 716, any one or more appropriate actions may be taken (e.g., error message or alert sent to endpoint, data brokerage system 70, and/or data provider 32, etc.). If it is determined at 712, that the evidence of rights presented in the request from endpoint 50 is valid, then endpoint 50 is authenticated and may access the instrument data. At 714, the instrument data is provided to endpoint 50 based on the subscription.

It should also be noted that data provisioning system 60 may perform other checks against access rights to determine whether to authenticate an endpoint. For example, data provisioning system 60 may perform a check on the maximum number of endpoints specified in the access rights information. Accordingly, when an endpoint presents evidence of rights, data provisioning system 60 may not authenticate the endpoint if the evidence of rights has already been presented to data provisioning system 60 by the maximum number of allowable endpoints. In another example, data provisioning system 60 may not authenticate an endpoint if the endpoint, and/or the evidence of rights presented by the endpoint, is associated with a secondary data consumer system 40B and the originally purchased access rights do not include the right to transfer, sell, or otherwise distribute the access rights to secondary data consumers. In yet another example, data provisioning system 60 may not authenticate an endpoint if a contract period has expired.

Note that in certain example implementations, the data brokering functions outlined herein may be implemented by logic encoded in one or more machine readable storage media (e.g., embedded logic provided in an application specific integrated circuit (ASIC), digital signal processor (DSP) instructions, software (potentially inclusive of object code and source code) to be executed by a processor, or other similar machine, etc.), which can include non-transitory media. In some of these instances, memory elements (e.g., memory elements 29, 49A, 49B, 59, 69, and 79) can store data and information used for the operations described herein. This includes the memory elements being able to store software, logic, code, or processor instructions that are executed to carry out the activities described in this Specification. Additionally, each of the components of communication system 10 may include a processor (e.g., processors 28, 48A, 48B, 58, 68, 78) that can execute software or an algorithm to perform data brokering activities as discussed herein. A processor can execute any type of instructions associated with the data and information to achieve the operations detailed herein. In one example, the processors (e.g., processors 28, 48A, 48B, 58, 68, 78) could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (FPGA), an erasable programmable read only memory (EPROM), an electrically erasable programmable ROM (EEPROM)) or an ASIC that includes digital logic, software, code, electronic instructions, or any suitable combination thereof. Any of the potential processing elements, modules, and machines described herein should be construed as being encompassed within the broad term ‘processor.’ Each of the components can also include suitable interfaces for receiving, transmitting, and/or otherwise communicating data or information in a network environment.

In one example implementation, components of communication system 10 (e.g., 20, 30, 40A, 40B, 50, 60, 70) may include software modules (shown in FIG. 2) in order to achieve, or to foster, thee brokering functions outlined herein. These modules can be suitably combined or partitioned in any appropriate manner, which may be based on particular configuration and/or provisioning needs. The components of communication system 10 (e.g., 20, 30, 40A, 40B, 50, 60, 70) can include volatile and/or nonvolatile memory elements for storing data and information, including instructions and/or logic, to be used in achieving the brokering activities, as discussed herein. These components may further keep data and information in any suitable memory element (e.g., random access memory (RAM), read-only memory (ROM), programmable ROM (PROM), EPROM, EEPROM, a disk drive, a floppy disk, a compact disk ROM (CD-ROM), a digital versatile disk (DVD), flash memory, a magneto-optical disk, an application specific integrated circuit (ASIC), or other types of nonvolatile machine-readable storage media that are capable of storing data and information), software, hardware, firmware, or in any other suitable component, device, element, or object where appropriate and based on particular needs. Any of the memory items discussed herein (e.g., memory elements 29, 49A, 49B, 59, 69, 79, etc.) should be construed as being encompassed within the broad term ‘memory element.’ Moreover, the information being used, tracked, provided, communicated, presented, transferred, distributed, sold, passed, sent, or received in communication system 10 could be provided in any repository, database, register, queue, table, cache, or other storage structure, all of which can be referenced at any suitable timeframe. Any such storage options may also be included within the broad term ‘memory element’ as used herein.

Note that with the examples provided herein, interaction may be described in terms of two, three, or four network elements and/or computing systems. However, this has been done for purposes of clarity and example only. In certain cases, it may be easier to describe one or more of the functionalities of a given set of flows by only referencing a limited number of network elements and/or computing systems. It should be appreciated that communication system 10 (and its teachings) are readily scalable and can accommodate a large number of components, as well as more complicated/sophisticated arrangements and configurations. Accordingly, the examples provided should not limit the scope or inhibit the broad teachings of communication system 10 as potentially applied to a myriad of other architectures.

It is also important to note that the operations in the preceding flow diagrams and interaction diagrams (i.e., FIGS. 3A-3D and 4-7) illustrate only some of the possible operations that may be executed by, or within, communication system 10. Some of these operations may be deleted or removed where appropriate, or these operations may be modified or changed considerably without departing from the scope of the present disclosure. In addition, a number of these operations have been described as being executed concurrently with, or in parallel to, one or more additional operations. However, the timing of these operations may be altered considerably. The preceding operational flows have been offered for purposes of example and discussion.

Also note that, as used herein, unless expressly stated to the contrary, the phrases ‘at least one of’ and ‘one or more of’ used in reference to a list of two or more items is intended to cover all of the following interpretations: any one of the items in the list, all of the items in the list, and any combination of the items in the list. Additionally, unless expressly stated to the contrary, any of the terms ‘first’, ‘second’, ‘third’, etc., used in reference to a particular item is intended to distinguish the particular item (e.g., element, condition, module, activity, operation, claim element, etc.) it describes, but is not intended to indicate any type of order, rank, importance, temporal sequence, or hierarchy of the item. For example, ‘first X’ and ‘second X’ are intended to designate two separate X items that are not necessarily limited by any order, rank, importance, temporal sequence, or hierarchy of the two items.

Substantial flexibility is provided by communication system 10 in that any suitable arrangements, chronologies, configurations, and timing mechanisms may be provided without departing from the teachings of the present disclosure. Additionally, although communication system 10 has been illustrated with reference to particular elements and operations that facilitate the communication process, these elements and operations may be replaced by any suitable architecture or process that achieves the intended functionality of communication system 10.

What is claimed is:

1. A method, comprising:
determining attributes associated with an instrumented entity;
determining contract terms for access rights to instrument data associated with the instrumented entity;
creating, at least in part by a marketing module, a data offering for the access rights based, at least in part, on the attributes and the contract terms;
publishing the data offering; and
providing evidence of rights to a primary data consumer system if a purchase request for the access rights is accepted, wherein the evidence of rights indicates the access rights are purchased.

2. The method of claim 1, wherein the instrument data is provided to an endpoint in real-time according to access rights information when the endpoint presents the evidence of rights to one of a data provisioning system and an instrument that generates the instrument data.

3. The method of claim 1, further comprising:
receiving one or more subscription parameters configured by a user after the access rights are purchased.

4. The method of claim 3, wherein a data provisioning system is configured to provide the instrument data to an endpoint based, at least in part, on the one or more subscription parameters.

5. The method of claim 4, wherein the data provisioning system is configured to provide the instrument data to the endpoint based, at least in part, on access rights information, wherein at least one of the subscription parameters supersedes at least one contract term specified in the access rights information.

6. The method of claim 1, wherein the contract terms include a right to distribute the purchased access rights to another data consumer by passing the evidence of rights to another data consumer system.

7. The method of claim 1, wherein the contract terms specify a costing basis for accessing the instrument data.

8. The method of claim 1, wherein the contract terms specify a cost based on at least one of a data access time and a data speed.

9. The method of claim 1, further comprising:
determining a unique identifier associated with the data offering; and
mapping the unique identifier to the attributes and the contract terms.

10. The method of claim 2, wherein the primary data consumer system is the endpoint.

11. A system, comprising:
a data brokerage system configured to:
determine attributes associated with an instrumented entity;
determine contract terms for purchasing access rights to instrument data associated with the instrumented entity;
create a data offering for the access rights based, at least in part, on the attributes and the contract terms;
publish the data offering; and
provide evidence of rights to a primary data consumer system if a purchase request for the access rights is accepted, wherein the evidence of rights indicates the access rights are purchased.

12. The system of claim 11, further comprising:
a data provisioning system configured to:
receive, from an endpoint, a request to access the instrument data; and
send the instrument data to the endpoint if the evidence of rights is received from the endpoint.

13. The system of claim 12, wherein the instrument data is sent to the endpoint based, at least in part, on one or more subscription parameters configured by a user.

14. The system of claim 13, wherein the one or more subscription parameters include at least one of a frequency to send the instrument data, one or more specified data elements of the instrument data to send, an amount of the instrument data to send, and a subscription period during which the one or more subscription parameters remain valid.

15. The system of claim 12, wherein the instrument data is sent in real-time.

16. The system of claim 12, wherein the contract terms include a right to distribute the access rights to a secondary data consumer by passing the evidence of rights to a secondary data consumer system.

17. At least one machine readable storage medium having instructions stored thereon for brokering instrument data, wherein the instructions when executed by at least one processor cause the at least one processor to:
determine one or more attributes associated with an instrumented entity;
determine one or more contract terms for access rights to instrument data associated with the instrumented entity;
create a data offering for the access rights based, at least in part, on the attributes and the contract terms;
publish the data offering; and
provide evidence of rights to a primary data consumer system if a purchase request for the access rights is accepted, wherein the evidence of rights indicates the access rights are purchased.

18. The at least one machine readable storage medium of claim 17, wherein the instructions when executed by the at least one processor cause the at least one processor to:
determine one or more other attributes that include dynamic data associated with the instrument data.

19. The at least one machine readable storage medium of claim 17, wherein the one or more attributes include static data associated with the instrumented entity, wherein the static data includes at least one of: a type of the instrumented entity, a location of the instrumented entity, and an owner of the instrumented entity.

20. A method, comprising:
determining one or more attributes indicating a type of instrumented entity and a type of instrument data;
creating, at least in part by a marketing module, a data request for access rights to instrument data associated with the one or more attributes;
publishing the data request;
creating a data offering, in response to the data request, for access rights to available instrument data, the access rights based, at least in part, on one or more contract terms; and
providing evidence of rights to a primary data consumer system if a purchase request for the access rights to the available instrument data is accepted, wherein the evidence of rights indicates the access rights are purchased.
